(19) United States
(12) Patent Application Publication
(10) Pub. No.: US 2020/0143242 A1
(43) Pub. Date: May 7, 2020

(54) SYSTEM AND METHOD FOR CREATING AND PROVIDING CRIME INTELLIGENCE BASED ON CROWDSOURCED INFORMATION STORED ON A BLOCKCHAIN

(71) Applicant: INTELLI NETWORK CORPORATION, Calgary Alberta (CA)

(72) Inventor: Kamea Aloha LAFONTAINE, Calgary (CA)

(21) Appl. No.: 16/669,801

(22) Filed: Oct. 31, 2019

Related U.S. Application Data
(60) Provisional application No. 62/754,071, filed on Nov. 1, 2018.

(51) Int. Cl. G06N 3/08; G06Q 50/26; H04L 9/30; H04L 9/08; H04L 9/32; H04L 9/06

(52) U.S. Cl. CPC G06N 3/08; G06Q 50/265; H04L 9/0643; H04L 9/088; H04L 9/3247; H04L 9/30

(57) ABSTRACT

A system and method for creating and providing crime intelligence based on crowdsourced information stored on a blockchain, where the crowdsourced information is analyzed and evaluated preferably according to an artificial intelligence (AI) model and users are rewarded for providing timely, valuable, and accurate crime tips. The crowdsourced information may be obtained in any suitable manner, including but not limited to written text, such as a document, or audio information.

### FIELD OF INVENTION

The present invention pertains to a system and method for creating and providing crime intelligence based on crowdsourced information stored on a blockchain, and in particular, to such a system and method uses an artificial intelligence (AI) engine to analyze and evaluate such crowdsourced information to ensure the validity and integrity of the crime tips submitted by users.

### BACKGROUND OF THE INVENTION

Safety is a major concern for people living in a civilized society. People make life and business decisions based on reported crime and reputation of an area. For example, a person may extend his or her travel time to avoid traveling through an area of high crime (e.g., robbery, vehicle theft). Or, a business may not service a particular area because of concern for its employee safety.

Prior to visiting a specific area, people often conduct online research about crime reports of the specific area. However, these reports are often unreliable because people under-report crimes, if they reported the crime at all. For example, the public reports less than one-third of all crime to the police. Moreover, neighborhood-watch programs are on the decline, which translates into less crime reported by the public.

In addition, people may fear the social backlash of reporting a crime. By reporting a crime, the victim does not receive any anonymity and might be ridiculed or ostracized by society. For example, in sexual assault cases, the victim might be called a liar or publicly shamed or humiliated if the sexual assault case involves a high-profile public figure.

Sharing crime information online is dangerous, especially if authorities have not apprehended the person who committed the crime. By sharing certain information online, the victim might unwilling invite a second attack (retaliation) by the perpetrator of the original crime or by another person.

With all of the above issues, the crime data might not be publicly available because authorities are not tracking crime statistics or have declined to share the data with the public. When the crime data is publicly available, the data might not be easily accessible or may lack sufficient detail.

Therefore, what is needed is a system and method for crime intelligence that provides privacy and anonymity, is free from censorship, incentives the public to share information, and assesses the collective reported intelligence of the crowd.

### SUMMARY OF THE INVENTION

According to at least some embodiments, the present invention provides a system and method for creating and providing crime intelligence based on crowdsourced information stored on a blockchain, where the crowdsourced information is analyzed and evaluated preferably according to an artificial intelligence (AI) model and users are rewarded for providing timely, valuable, and accurate crime tips. The crowdsourced information may be obtained in any suitable manner, including but not limited to written text, such as a document, or audio information.

The crowdsourced information may be any type of information that can be gathered from a plurality of user-based sources. “User-based sources” means information that is provided by individuals. Such information may be based upon sensor data, data gathered from automated measurement devices and the like, but it preferably then provided by individual users of an app or other software.

Preferably, the crowdsourced information includes information that relates to a person, that impinges upon an individual or a property of that individual, or that is specifically directed toward a person.

In some implementation, the system features a plurality of user computational devices in communicate with one or more servers through a computer network, such as the internet. Each user computational device features a user app interface for interacting with the user through an input device and display device, for example a touch screen on a tablet or mobile device.

Each server features a server app interface, an artificial intelligence (AI) engine, and a blockchain node. The server app interface communicates with the user computational device to receive and pass information, such a crime tips and crime intelligence reports.

The AI engine analyzes and evaluates the crime tips submitted by users. The value the AI engine assigns to a crime tip determines the payment token reward that a user receives for submitting a crime tip. After a value is assigned the crime tip, the server, operating as a blockchain node on the blockchain network, writes the information to the blockchain.

To request a crime intelligence report, a user must submit payment in form of tokens to receive the crime intelligence report. The entire transaction is controlled by a smart contract on the blockchain. When a user pays for a crime intelligence report, the submitting user, who submitted the crime tip that is contained inside of the crime intelligence report, receives a secondary token reward.

Preferably, the process for evaluating crime tips or information includes removing any emotional content or bias from the crowdsourced information. For example, crime relates to people personally—whether to their body or their property. Therefore, crime tips impinge directly on people's sense of themselves and their personal space. Desensationalizing this information is preferred to prevent error of judgement. For these types of information, removing any emotionally laden content is important to at least reduce bias in crime intelligence reports that are generated from the crime tips.

Preferably, the evaluation process also includes determining a gradient of severity of the information, and specifically of the situation that is reported with the information. For example and without limitation, for crime, there is typically an unspoken threshold, gradient or severity in a community that determines when a crime would be reported. For a crime that is not considered to be sufficiently serious to call the police, individuals are more likely to report those crimes as crime tips. Thereby, providing more crime intelligence that would otherwise be available.

Such crowdsourcing may be used to find the small, early beginnings of crime and map the trends and reports for the community.

### BRIEF DESCRIPTION OF THE DRAWINGS

These and other features, aspects, and advantages of the present invention will become better understood with regard to the following description, appended claims, and accompanying drawings where:

FIG. 1A and 1B illustrate a system for creating and providing crime intelligence based on crowdsourced information, in accordance with one or more implementations of the present invention;

FIG. 2 illustrates a non-limiting exemplary AI engine, in accordance with one or more implementations of the present invention;

FIG. 3 illustrates a method for analyzing and evaluating received crime information from a plurality of users through crowdsourcing, in accordance with one or more implementations of the present invention;

FIG. 4 illustrates a method for providing crime intelligence information based on a user's requests, in accordance with one or more implementations of the present invention;

FIG. 5 illustrates a method for receiving crime information submitted by users, in accordance with one or more implementations of the present invention;

FIG. 6 illustrates a method for providing crime intelligence information based on a user's request for a specified area, in accordance with one or more implementations of the present invention;

FIG. 7 shows a method for processing businesses' advertisement requests and providing notifications to businesses that exchanged tokens for advertising to users who request crime intelligence for a specific area, in accordance with one or more implementation of the present invention;

FIGS. 8A to 8F illustrate a representation of the different token reward systems, validation of transactions, and purchase of crime tips and advertisements—in accordance with one or more implementations of the present invention;

FIGS. 9A and 9B relate to non-limiting exemplary systems and flows for providing information to an artificial intelligence system with specific models employed and then analyzing the information, in accordance with one or more implementations of the present invention;

FIG. 10 relates to a non-limiting exemplary flow for analyzing information by an AI engine as described herein, in accordance with one or more implementations of the present invention;

FIG. 11 relates to a non-limiting exemplary flow for training the AI engine as described herein, in accordance with one or more implementations of the present invention;

FIG. 12 relates to a non-limiting exemplary method for obtaining training data for training the neural network models as described herein, in accordance with one or more implementations of the present invention;

FIG. 13 relates to a non-limiting exemplary method for evaluating a source for data for training and analysis as described herein, in accordance with one or more implementations of the present invention;

FIG. 14 relates to a non-limiting exemplary method for performing context evaluation for data, in accordance with one or more implementations of the present invention;

FIG. 15 relates to a non-limiting exemplary method for connection evaluation for data, in accordance with one or more implementations of the present invention;

FIG. 16 relates to a non-limiting exemplary method for source reliability evaluation;

FIG. 17 relates to a non-limiting exemplary method for a data challenge process;

FIG. 18 relates to a non-limiting exemplary method for a reporting assistance process;

FIG. 19 illustrates a method of securing the user wallet 116 through a verifiable means of connecting wallet seeds in an obfuscated way with a particular known user identity;

FIG. 20 illustrates a method of user creating a crime tip; and

FIG. 21 illustrates the method of users validating or rejecting a crime tip.

### DETAILED DESCRIPTION

In describing the novel system and method for creating and providing crime intelligence based on crowdsourced information stored on a blockchain, the provided examples should not be deemed to be exhaustive. While one implementation is described hereto, it is to be understood that other variations are possible without departing from the scope and nature of the present invention.

A blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin. The recorded data records on the blockchain are enforced cryptographically and stored on the nodes of the blockchain.

A blockchain provides numerous advantages over traditional databases. A large number of nodes of a blockchain may reach a consensus regarding the validity of a transaction contained on the transaction ledger. Similarly, when multiple versions of a document or transaction exist on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain.

In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Preferably, the blockchain(s) that is/are implemented are capable of running code, to facilitate the use of smart contracts. Smart contracts are computer processes that facilitate, verify and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, financial cryptography schemes for financial contracts, admission control schemes, token bucket algorithms, other quality of service mechanisms for assistance in facilitating network service level agreements, person-to-person network mechanisms for ensuring fair contributions of users, and others.

Smart contracts may also be described as pre-written logic (computer code), stored and replicated on a distributed storage platform (e.g. a blockchain), executed/run by a network of computers (which may be the same ones running the blockchain), which can result in ledger updates (cryptocurrency payments, etc).

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

Not all blockchains can execute all types of smart contracts. For example, Bitcoin cannot currently execute smart contracts. Sidechains, i.e. blockchains connected to Bitcoin's main blockchain could enable smart contract functionality: by having different blockchains running in parallel to Bitcoin, with an ability to jump value between Bitcoin's main chain and the side chains, side chains could be used to execute logic. Smart contracts that are supported by sidechains are contemplated as being included within the blockchain enabled smart contracts that are described below.

For all of these examples, security for the blockchain may optionally and preferably be provided through cryptography, such as public/private key, hash function or digital signature, as is known in the art.

Although the below description centers around trading of cryptocurrencies, it is understood that the systems and methods shown herein would be operative to trade any type of cryptoasset or data on the blockchain.

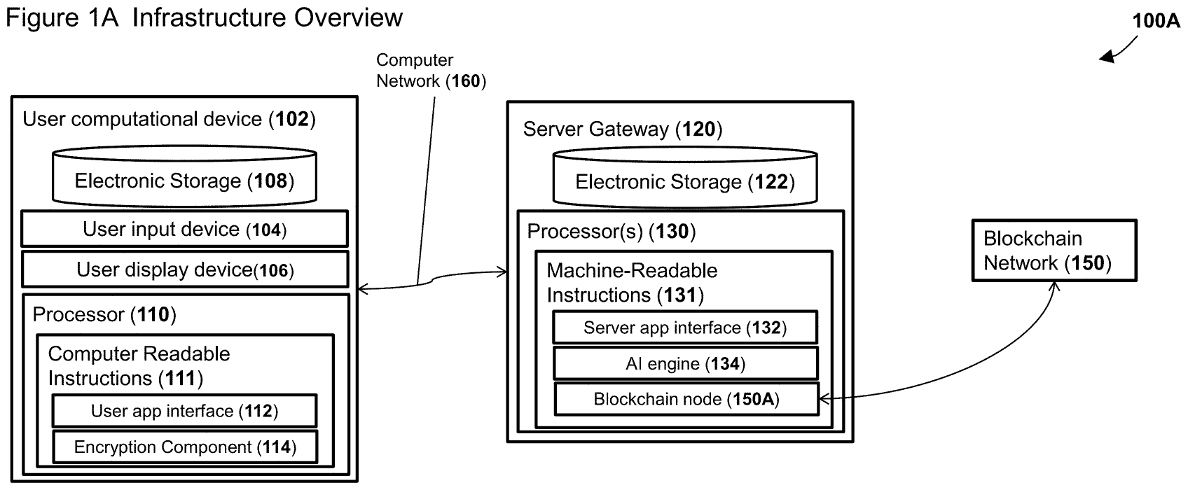

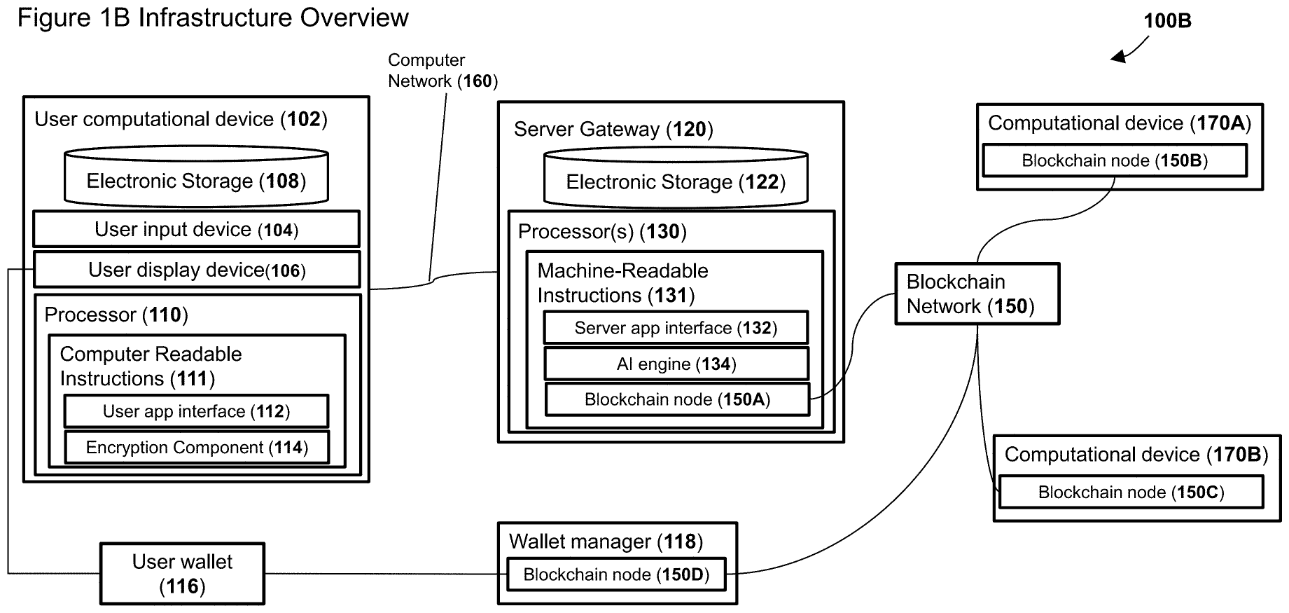

FIG. 1A illustrates a system 100A configured for creating and providing crime intelligence based on crowdsourced information, in accordance with one or more implementations of the present invention.

In some implementation, the system 100A may include a user computational device 102 and a server gateway 120 that communicates with the user computational device through a computer network 160, such as the internet. (“Server gateway” and “server” are equivalent and may be used interchangeably). The server gateway 120 also communicates with a blockchain network 150. A user may access the system 100A via user computational device 102.

The user computational device 102 features a user input device 104, a user display device 106, an electronic storage 108 (or user memory), and a processor 110 (or user processor). The user computational device 102 may optionally comprise one or more of a desktop computer, laptop, PC, mobile device, cellular telephone, and the like.

The user input device 104 allows a user to interact with the computational device 102. Non-limiting examples of a user input device 104 are a keyboard, mouse, other pointing device, touchscreen, and the like.

The user display device 106 displays information to the user. Non-limiting examples of a user display device 106 are computer monitor, touchscreen, and the like.

The user input device 104 and user display device 106 may optionally be combined to a touchscreen, for example.

The electronic storage 108 may comprise non-transitory storage media that electronically stores information. The electronic storage media of electronic storage 108 may include one or both of system storage that is provided integrally (i.e., substantially non-removable) with a respective component of system 100A and/or removable storage that is removably connected to a respective component of system 100A via, for example, a port (e.g., a USB port, a fireware part, etc.) or a drive (e.g., a disk drive, etc.). The electronic storage 108 may include one or more of optically readable storage media (e.g., optical discs, etc.), magnetically readable storage medium (e.g., flash drive, etc.), and/or other electronically readable storage medium. The electronic storage 108 may include one or more virtual storage resources (e.g., cloud storage, a virtual private network, and/or other virtual storage resources). The electronic storage 108 may store software algorithms, information determine by processor, and/or other information that enables components of a system 100A to function as described herein.

The processor 110 refers to a device or combination of devices having circuity used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

The process 110 is configured to execute readable instructions 111. The computer readable instructions 111 include a user app interface 104, encryption component 114, and/or other components.

The user app interface 104 provides a user interface presented via the user computational device 102. The user app interface 104 may be a graphical user interface (GUI). The user interface may provide information to the user. In some implementations, the user interface may present information associated with one or more transactions. The user interface may receive information from the user. In some implementations, the user interface may receive user instructions to perform a transaction. The user instructions may include a selection of a transaction, a command to perform a transaction, and/or information associated with a transaction.

Referring now to server gateway 120 depicted in FIG. 1, the server gateway 120 communicates with the user computational device 102 and the blockchain network 150. The server gateway 120 facilitates the transfer of information to and from the user and the blockchain. In some implementations, the system 100A may include one or more server gateway 120.

The server gateway 120 features an electronic storage 122 (or server memory), one or more processor(s) 130 (or server processor), an artificial intelligence (AI) engine 134, blockchain node 150A, and/or other components. The server gateway 120 may include a plurality of hardware, software, and/or firmware components operating together to provide the functionality attributed herein to server gateway 120.

The electronic storage 122 may comprise non-transitory storage media that electronically stores information. The electronic storage media of electronic storage 122 may include one or both of system storage that is provided integrally (i.e., substantially non-removable) with a respective component of system 100A and/or removable storage that is removably connected to a respective component of system 100A via, for example, a port (e.g., a USB port, a fireware part, etc.) or a drive (e.g., a disk drive, etc.). The electronic storage 122 may include one or more of optically readable storage media (e.g., optical discs, etc.), magnetically readable storage medium (e.g., flash drive, etc.), and/or other electronically readable storage medium. The electronic storage 122 may include one or more virtual storage resources (e.g., cloud storage, a virtual private network, and/or other virtual storage resources). The electronic storage 122 may store software algorithms, information determine by processor, and/or other information that enables components of a system 100A to function as described herein.

The processor 130 may be configured to provide information processing capabilities in server gateway 120. As such, the processor 130 may include a device or combination of devices having circuity used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

The process 130 is configured to execute machine-readable instructions 131. The machine-readable instructions 131 include a server app interface 132, an artificial intelligence (AI) engine 134, a blockchain node 134, and/or other components.

The AI engine 134 may include machine learning and/or deep learning algorithms, which is explained later in greater detail. The AI engine 134 sorts, organizes, and assigned a value to the crime intelligence submitted by users.

The AI engine 134 evaluates the information using based on the following evaluation factors (e.g., time, uniqueness, level of verification, and context). As to the time factor, every blockchain data submission contains a timestamp. This timestamp is used to verify the exact time that a crime intelligence or report was submitted chronologically.

As to the uniqueness factor, the unique nature of each user account is used to validate information. The more detailed the report, and the more times that specific intel occurs over and over again, validates it as being increasingly probable and verified.

Level of verification factor takes into account the type of user providing the crime intelligence and the user's track record of reporting good crime intelligence. A user may be classified from the following non-limiting list: (1) super users, which are users that have a track record of providing valuable and reliable crime intelligence; and (2) trusted sources (e.g., police, private investigators, and good actors, etc.)

The context factor takes into account the circumstances upon which the incident occurred within the reported crime intelligence. Incidents that occur within high levels of context (e.g., a public shooting, a well-known incident, a geographical area where certain crimes occur more often) is used to help validate and determine the relevance of the crime intelligence reports.

In addition, external data (e.g., social media, private information databases, news/incidence reports) is layered and applied to the crime intelligence reports. The external data provides context for crime intelligence reports and is used to rate the validity score of the reported crime intelligence based on context. For example, if a user submits a report in Barcelona (which is the pickpocket capital of the world) about a pickpocket incident, then the AI engine 134 would rate this reported crime intelligence as being potentially more valid than a less common crime. Another example, if a user submits a report of a sexual assault occurring in winter on a public street out in public during the middle of the day, the AI engine 134 would rate this reported crime intelligence lower than common events like music festivals, where many drunken partiers are more likely to commit these kinds of offences.

The AI engine uses the evaluation factors to create and assign a numerical value to the reported crime intelligence. The numerical value may be determined by using a weighted average. Other means for determining the numerical value may be used, such as sum of values assigned to the evaluation factors.

The blockchain network 150 may include a system, computing platform(s), server(s), electronic storage, external resources(s), processor(s), and/or components associated with the blockchain.

FIG. 1B illustrates a variation of the system shown in FIG. 1A, in accordance with one or more implementations of the present invention. As shown, system 100B features the same elements of system 100A, but contains additional elements. The system 100B comprises a user computational device 102, a user wallet 116, a wallet manager 118, a server gateway 120, blockchain network 150, and computational devices 170A and 170B.

The user wallet 116 is in communication with the user computational device 102. The user wallet 116 is a holding software operated by computational device or platform which would hold or possess the crypto currency owned by the user and would store them in a secure manner. The use of wallet 116 in this example is shown as being managed by the wallet manager 118, operating block chain node 150D. Again, different blockchains would actually be operated for a purchase to occur, but in this case, what is shown is that wallet manager 118 also retains a complete copy of the blockchain by operating blockchain node 150D. In this non-limiting example, the user wallet 116 may optionally be located on a user computational device 102 and may simply be referred to by wallet manager 118 and/or may also be located in an off-site location, and for example, may be located in a server, a server farm, operated by or controlled by a wallet manager 118.

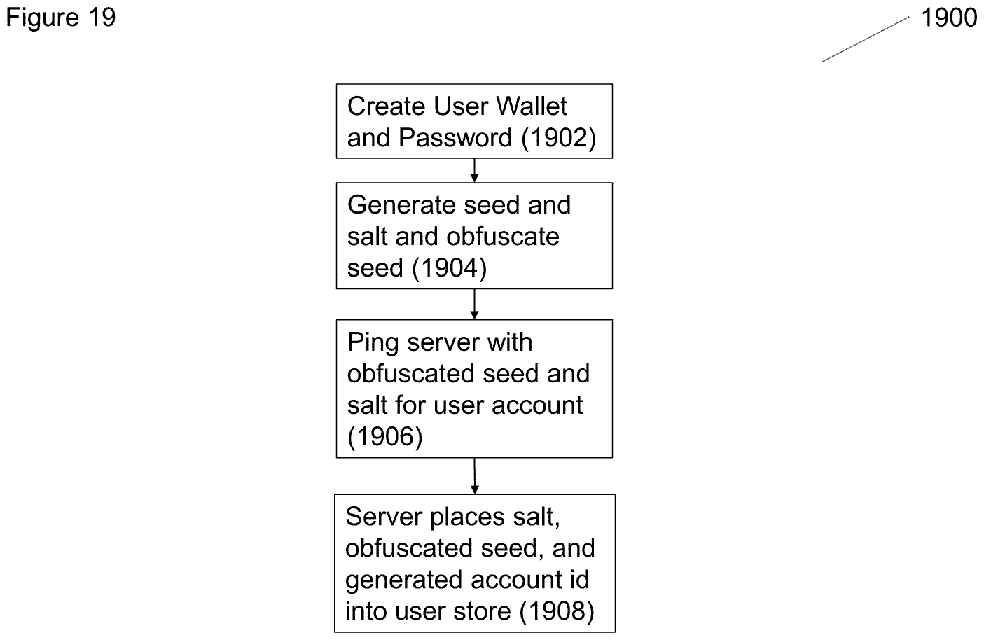

In this non-limiting example, then, the server gateway 120 would either verify that the user had the cryptocurrency available for purchase in user wallet 116, for example through direct communication with wallet manager 118 either directly, buy a computer-to-computer communication, which is not shown, alternatively, by executing a smart contract on the blockchain. If the server gateway 120 were to invoke a smart contract for purchase of crime intelligence data, then, again, this could be written onto the blockchain, such that the wallet manager 118 would then know that the user had used the cryptocurrency in the user wallet 116. Although not explained here, FIG. 19 explains how the user wallet 116 secures the user's information.

The blockchain network 150 is made of numerous computational devices operating as blockchain nodes. For illustration purposes, only computational devices 170A and 170B are shown, in addition to the server gateway 120, as part of the blockchain network 150 although the blockchain network 150 contains many more computational devices operating as blockchain nodes.

The computational device 170A operates a blockchain node 150B, and a computational device 170B operates a blockchain node 150C. Each such computational device comprises an electronic storage, which is not shown, for storing information regarding the blockchain. In this non-limiting example, blockchain nodes 150A, B, and C belong to a single blockchain, which may be any type of blockchain, as described herein. However, optionally, server gateway 112 may operate with or otherwise be in communication with different blockchains operating according to different protocols.

Blockchain nodes 150A, B, and C are a small sample of the blockchain nodes on the blockchain network 150. Although these nodes appear to be communicating in operation of the blockchain network 150, each computational device retains a complete copy of the blockchain. Optionally, if the blockchain were divided, then each computational device could perhaps retain only a portion of the blockchain.

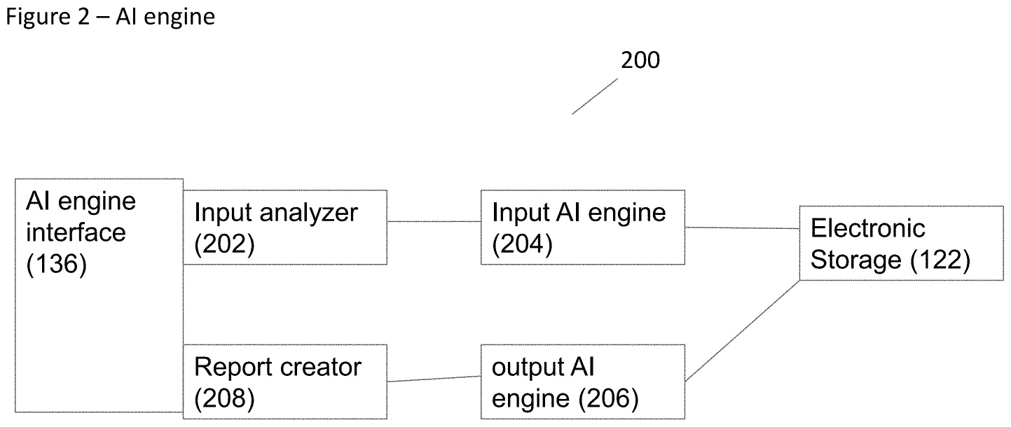

FIG. 2 relates to a non-limiting exemplary AI engine 134, which was previously shown with regard to FIGS. 1A and 1B. In this non-limiting example an AI engine interface 136 enables AI engine 134 to interface with other components on the server gateway which is not shown. AI engine interface 136 preferably interacts with an input and analyzer 202, which analyzes the input information such as for example information from a plurality of sources. The input AI engine 204 then analyzes this information, for example the aggregated to determine its quality, to group information according to a particular incident or according to other markers of information which can be helpful later on for determining the final report. This information is then stored in electronic storage 122.

When a recipient user wishes to request report or when a report is otherwise requested, the request is sent to AI engine interface 136, which interacts with the report creator 208. Report creator 208 provides information to an output AI engine 206, to determine the kinds of information to be obtained from electronic storage 122 and the type of analysis, for example for a single crime, or for a plurality of linked crimes, the analysis may include a temporal and geographical timeline indicating when and where certain events took place. The analysis may also include the level of confidence which has been assigned to whether or not the particular event actually occurred, such as for example, if it is known that a burglary occurred, but there's a lower probability of who the perpetrator is, then this information is indicated. For output AI engine 206 preferably the different data sources are provided, for example according to the different data qualities which have also preferably been sorted in electronic storage 122. Output AI engine 206 then provides this information for report creator 208, which puts it together into a coherent report, which is then output through AI engine interface 136.

Preferably, output AI engine 206, report creator 208, or a combination thereof, reviews the information and/or the final report to detect the presence of sensitive information. For example, such sensitive information may include without limitation personal identifying information (PII). PII is preferably removed to make the reports safe for public consumption and to achieve “privacy by design” throughout the user experience, for example to minimize harm to users in situations of swatting or doxxing. Such sensitive information may also include racially biased information, or information suffering from another type of bias, which is preferably removed in order to better inform and support the public, or other consumers of such information. Such analysis for sensitive information may be performed for example through machine learning algorithms as described herein.

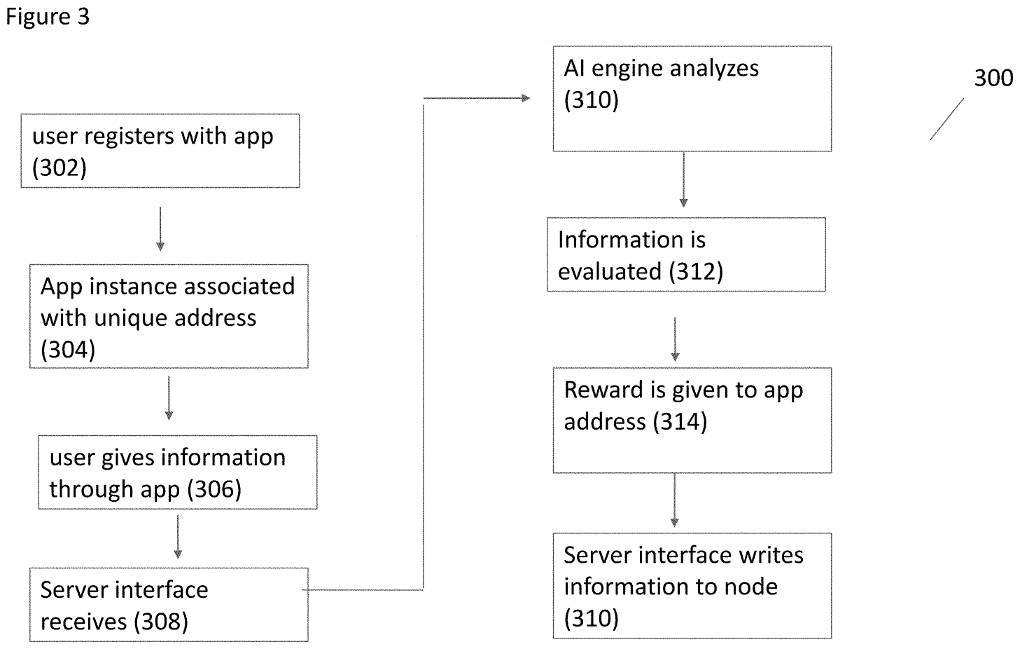

FIG. 3 illustrates a method 300 for analyzing and evaluating received crime information from a plurality of users through crowdsourcing, in accordance with one or more implementations of the present invention. In Step 302, the method 300 begins with a user registering with the application through the user app interface 112 operating on the user computational device 102. After the user registers with the application, the application instance is associated with a unique address (or unique ID) to the user account (Step 304). This may be the user registering in, but is preferably also associated with the app instance. Preferably, the app is downloaded and operated on a user mobile device as a user computational device, in which case the unique identifier may also be related to the mobile device.

Next, the user then gives information through the user app interface 112 (Step 306). The user app interface 112 communicates with the server app interface 132 operating on the server gateway 120.

The server app interface 132 receives the user's information (Step 308). Next, the AI engine 134 analyzes the information (Step 310) and then evaluates the information (Step 312) using its evaluation criteria (e.g., time, uniqueness, level of verification, and context). The reward (i.e., token) is given to the unique address of the user account (Step 314) based on evaluation of the AI engine 134. The server app interface 132 then writes the information to the blockchain node 150A.

Preferably, the AI engine 134 also removes any emotional content or bias from the crowdsourced information. For example, crime relates to people personally—whether to their body or their property. Therefore, crime tips impinge directly on preferred to prevent errors of judgement. For these types of information, removing any emotionally laden content is important to at least reduce bias.

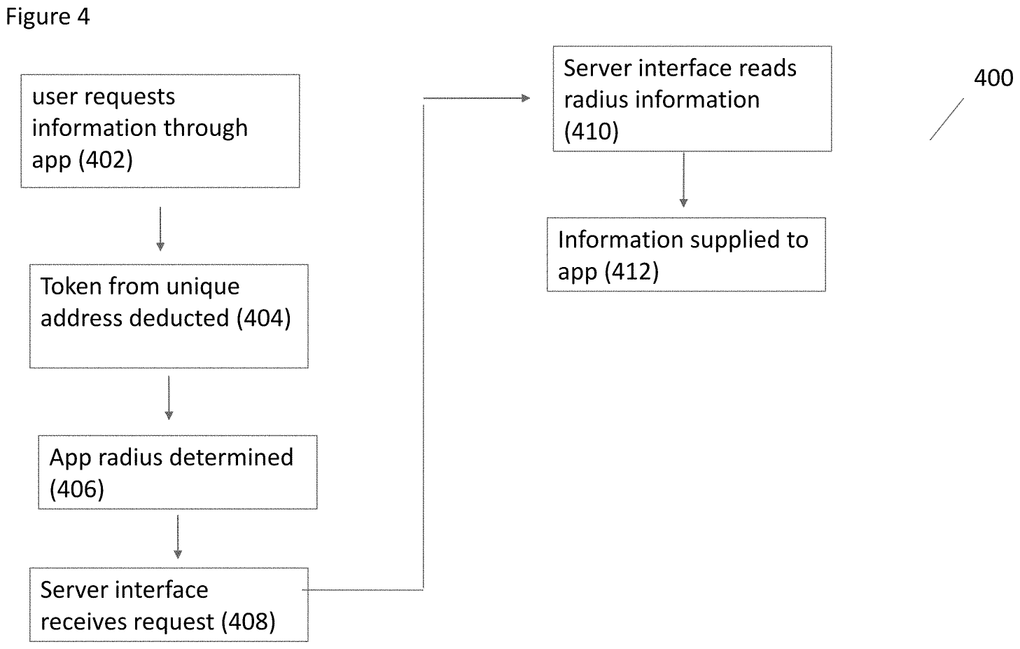

FIG. 4 illustrates a method 400 for providing crime intelligence information based a user's requests, in accordance with one or more implementations of the present invention. In Step 402, the method 400 begin this with a user requesting information through the user app interface 112 operating on the user computational device 102. Next, in Step 404, a token from the unique address is the deducted. The user app interface 112 then determines the app radius (Step 406). The user app interface 132 sends the user's request for crime intelligence information to the server app interface 132 operating on the server gateway 120. The server app interface 132 receives this request (Step 408) and then reads the radius information (Step 410). The server app interface 410 returns the requested information to the user app interface 112 (Step 412). Finally, the user accesses the information using the user app interface 112.

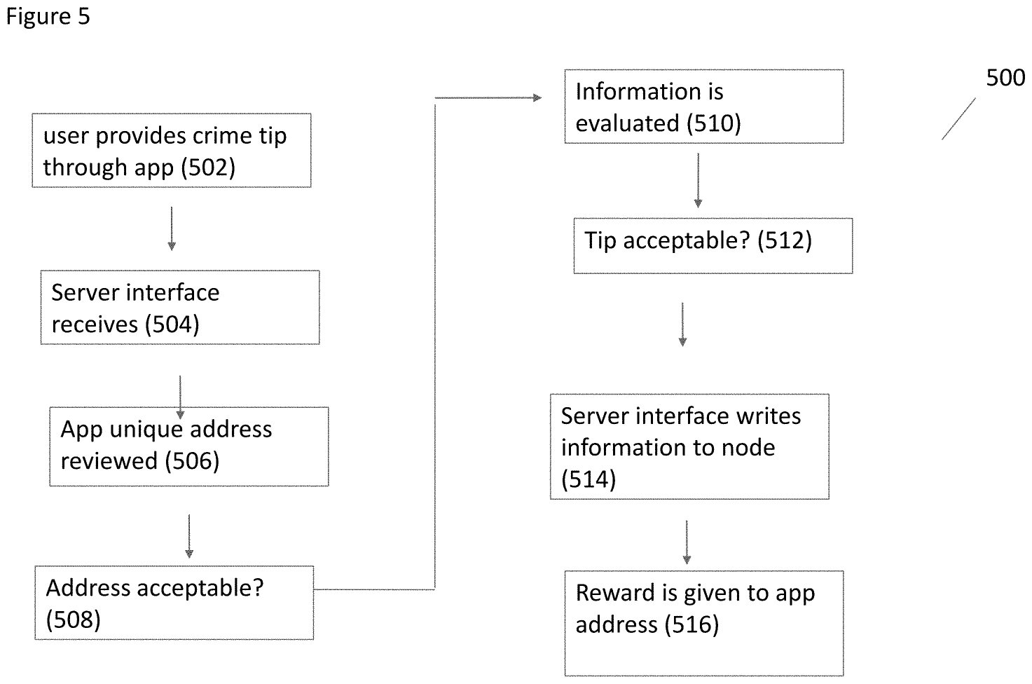

FIG. 5 illustrates a method 500 for receiving crime information submitted by users, in accordance with one or more implementations of the present invention. In Step 502, the method 500 begins with a user providing a crime tip through the user app interface 112 operating on the user computational device 102. The user app interface 112 then sends the crime tip to the server app interface 132 operating on the server gateway 120. The server app interface 132 receives the crime tip (Step 504) and then reviews the unique address (Step 506). If the server app interface 132 determines that the unique address is acceptable (Step 508), the AI engine 134 evaluates the crime tip using its evaluation criteria (e.g., time, uniqueness, level of verification, and context). If the tip is acceptable (Step 512), the server app interface 132 writes the information to the blockchain node 150A. Finally, the reward (i.e., token) is given to the unique address (Step 516).

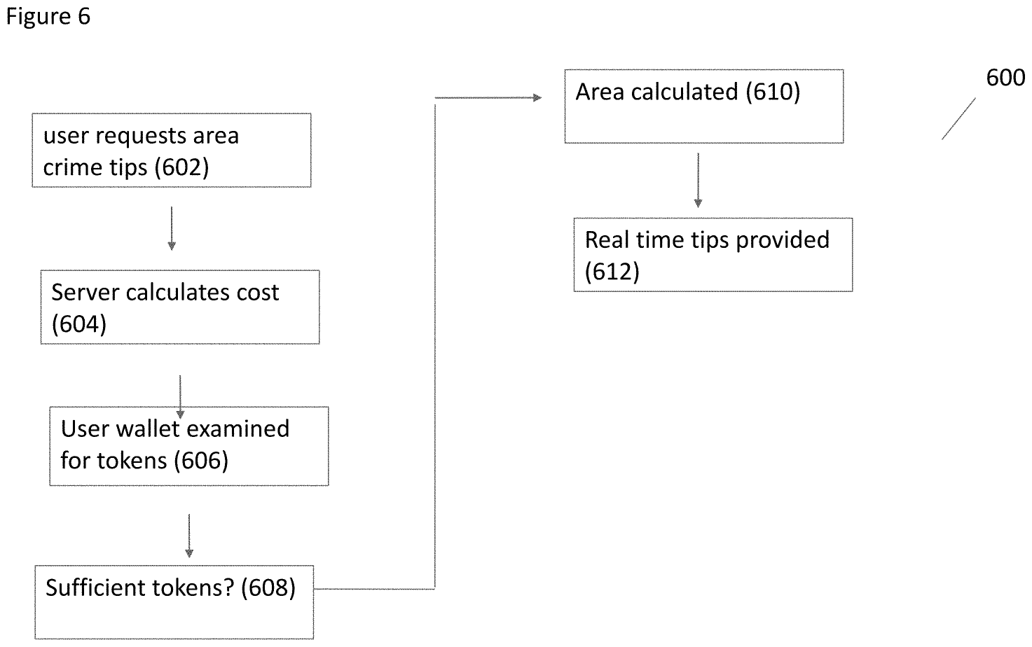

FIG. 6 illustrates a method 600 for providing crime intelligence information based a user's request for a specified area, in accordance with one or more implementations of the present invention. In Step 602, the method 600 begins with a user requesting crime tips in a specific area using the user app interface 112 operating on the user computational device 102. The user app interface 112 then sends the requested crime tips to the server app interface 132 operating on the server gateway 120. The server calculates the cost of the user's requested crime tips (Step 604).

The server gateway 120 would either verify that the user had the tokens available for purchase of the requested crime tips in the user wallet 116, for example through direct communication with the wallet manager 118, which is not shown, alternatively, by executing a smart contract on the blockchain network 150.

The user wallet 116 examines for tokens (Step 606) and determines whether the user has sufficient tokens for the requested crime tips (Step 608). If the user wallet 116 determines that the user has sufficient tokens, the wallet manager 118 executes the smart contract on the blockchain network 150 through the blockchain node 150D. The server gateway then calculates the area (Step 610) and provides real time crime tips to the user app interface 112 (Step 612). The user app interface 112 then communicates the real time crime tips to the user.

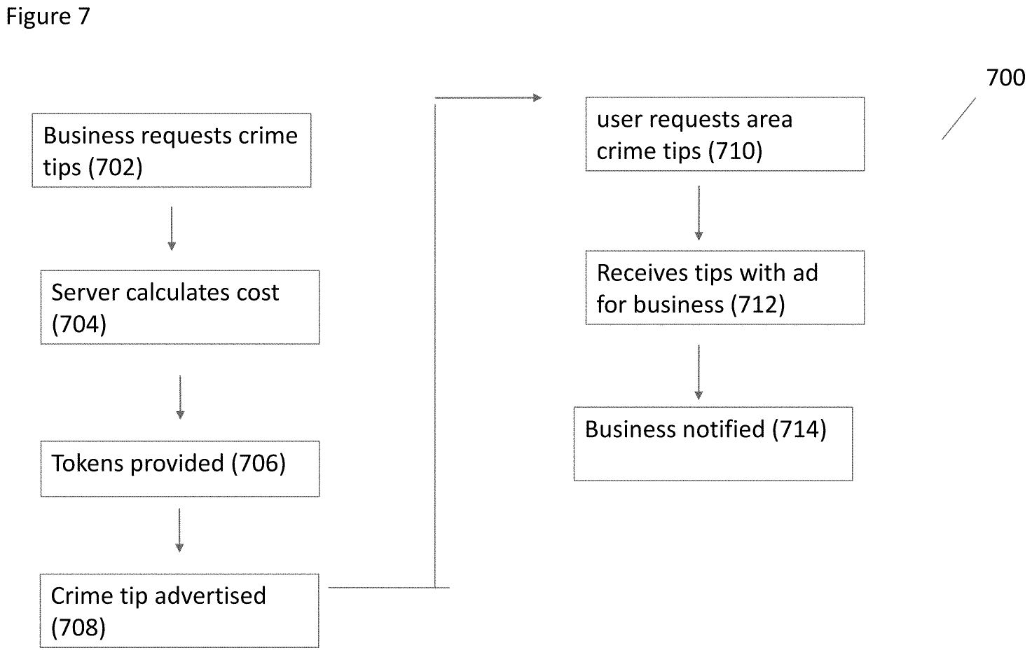

FIG. 7 shows a method for processing businesses' advertisement requests and providing notifications to businesses that exchanged tokens for advertising to users who request crime intelligence for a specific area, in accordance with one or more implementation of the present invention. In Step 702, the process 700 begins with the business user requesting crime tips using the user app interface 112 operating on the user computational device 102. The user app interface 112 then sends the requested crime tips to the server app interface 132 operating on the server gateway 120. The server calculates the cost of the business user's requested crime tips (Step 704). The business user provides tokens to purchase the advertisement (Step 706). The business user can use a user wallet 116 or other means for transferring tokens.

Once the purchased, the business user's ad will be advertised with the crime tip (Step 708). Next, the user requests an area crime tip (Step 710) as explained in FIG. 6. The user receives the requested crime tip along with the business user's ad (Step 712). The business user is also notified (Step 714) that the user has received the business user's ad.

The user wallet 116 examines for tokens (Step 706) and determines whether the user has sufficient tokens for the requested crime tips (Step 708). If the user wallet 116 determines that the user has sufficient tokens, the wallet manager 118 executes the smart contract on the blockchain network 150 through the blockchain node 150D. The server gateway then calculates the area (Step 710) and provides real time crime tips to the user app interface 112 (Step 712). The user app interface 112 then communicates the real time crime tips to the user.

In another embodiment, the user can received the business user's ad and crime tip based on user's geographical location by means of geofencing. For example, the user enters a specific geographical location (i.e., the business user's establishment and surrounding area) with a device, such as a mobile phone. The device location is determined by Global Positing System (GPS), Radio Frequency Identification (RFID) technology, Near Field Communication (NFC), Bluetooth, or similar wireless communication technology. Upon entering or residing inside the specific geographic location, the user receives notifications on the device, where the notification can be message from the business user, a business user's ad, or crime tip.

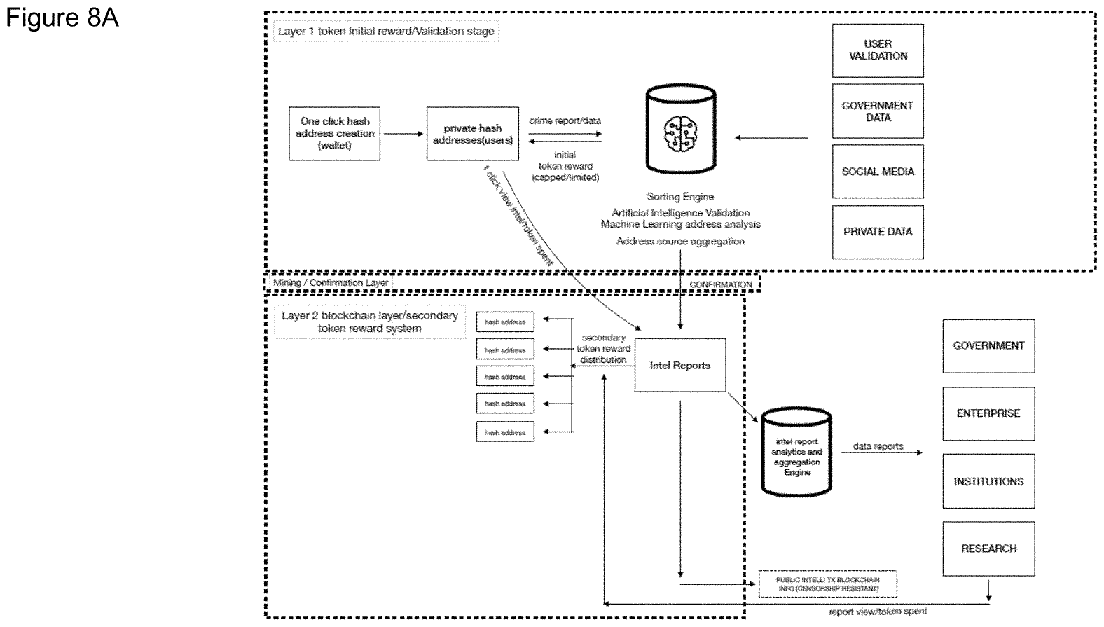

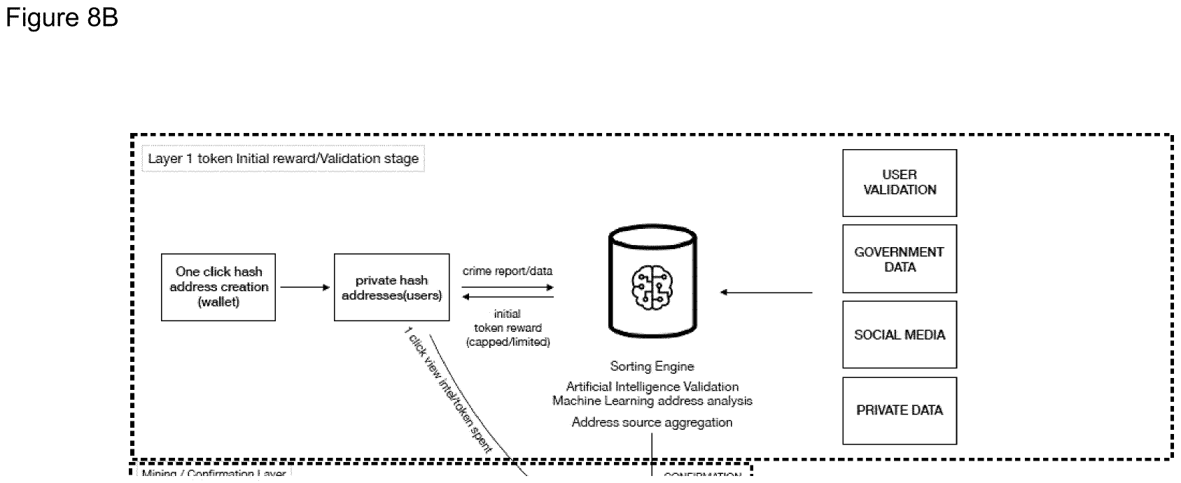

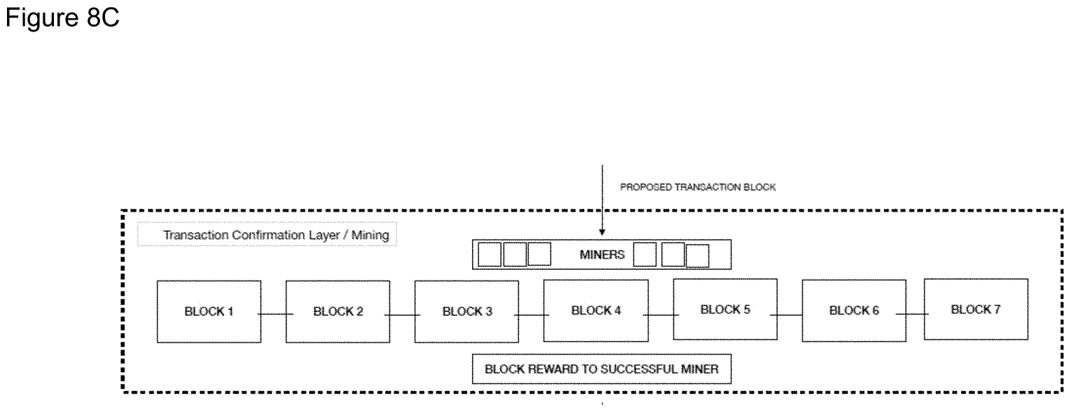

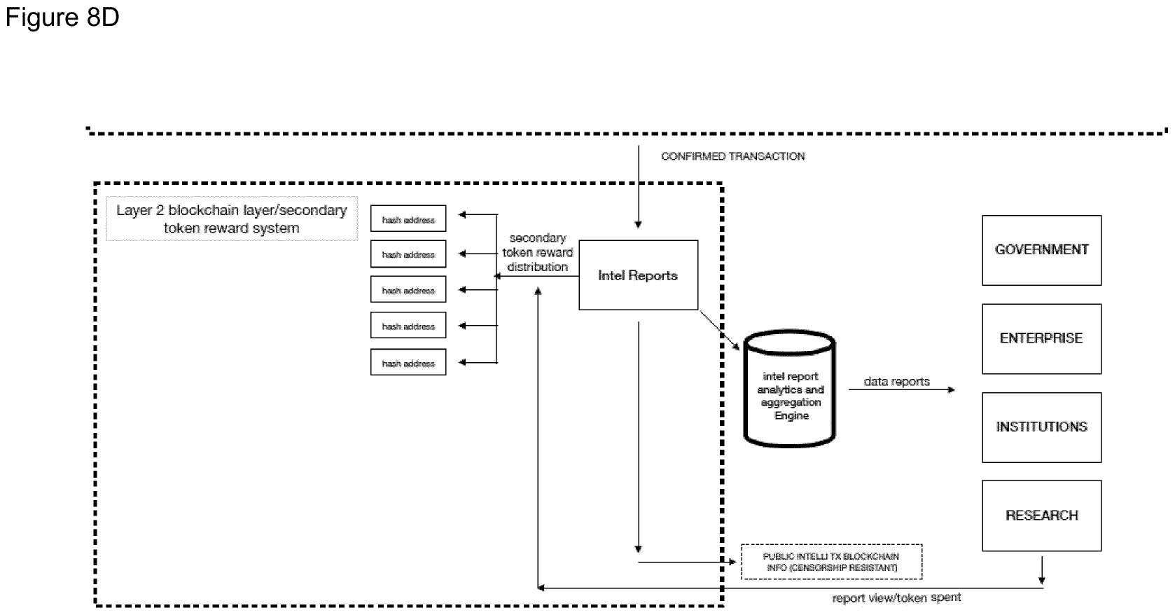

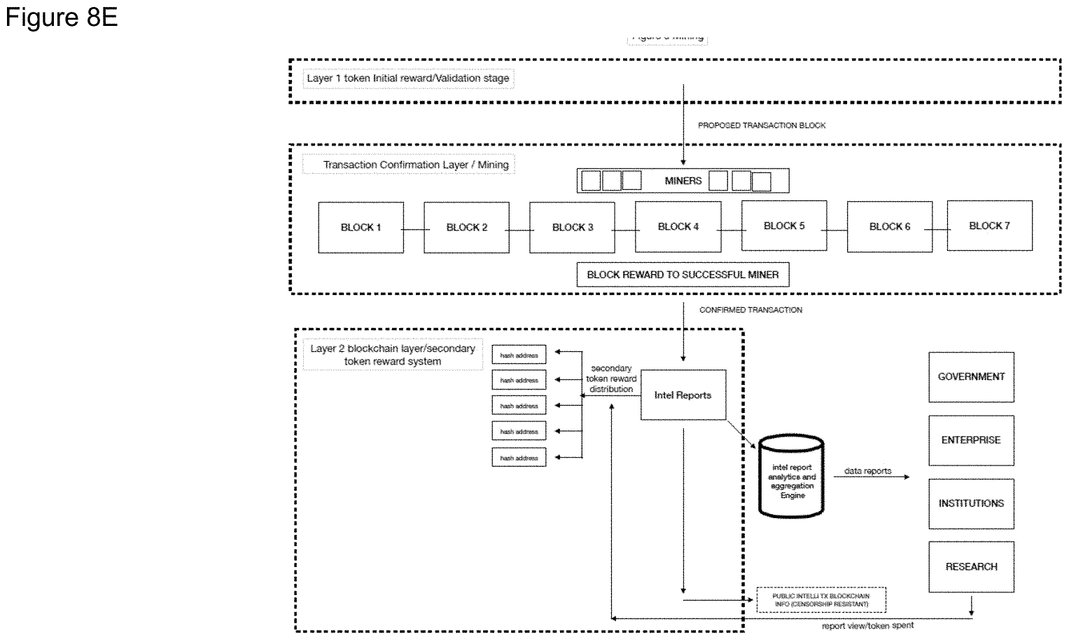

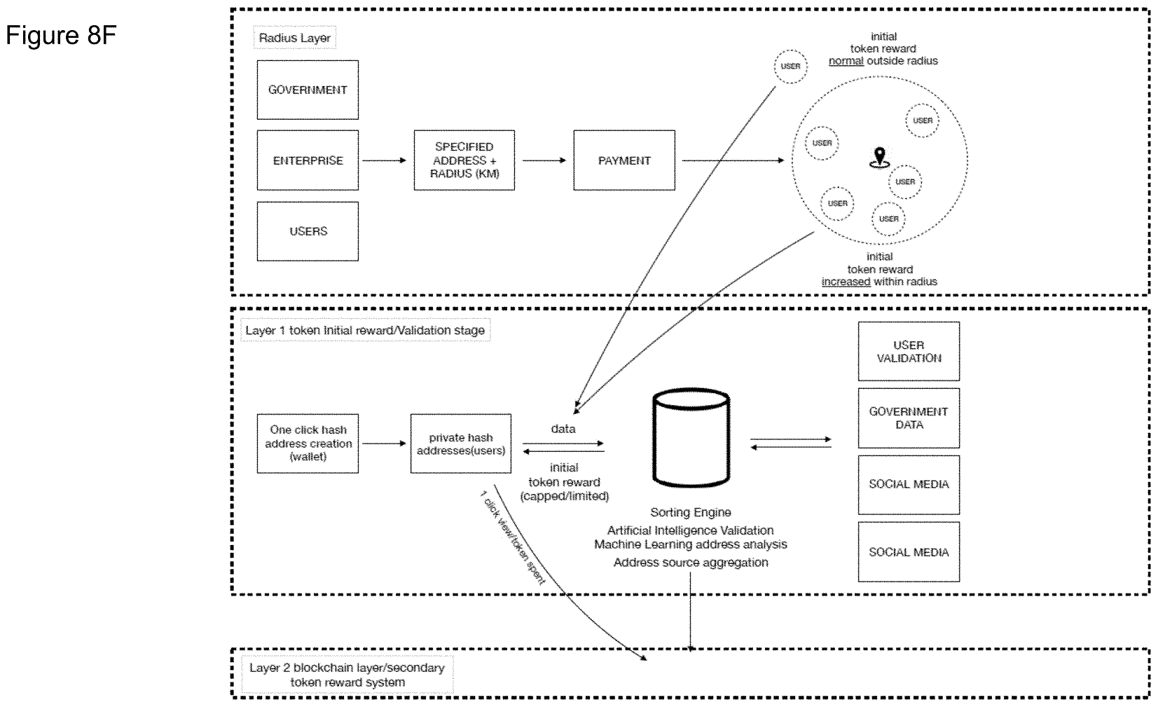

FIGS. 8A to 8F illustrate a representation of the different token reward systems, validation of transactions, and purchase of crime tips and advertisements—in accordance with one or more implementations of the present invention. FIGS. 8A to 8F show the different token reward systems, validation of transactions, and purchase of crime tips and advertisements. FIG. 8A provides a process overview of the token reward systems and validation of transactions.

FIG. 8B illustrates the token initial reward/validation stage as explained in FIG. 3. In FIG. 8B, process starts with the one-click hash address creation via the user wallet 116. Next, the user submits crime intelligence information or requests crime intelligence reports. If the user submits crime intelligence information, then the information is inputted into the sorting engine or AI engine 134. Here, the AI engine 134 validates the information based on a specific criteria as explained above and pulls information from other sources (e.g., government data, social media, private data, etc.) as means to validates the crime intelligence information submitted by the user. Based on the AI engine validation, the user receives an initial token reward in certain amount. The initial token reward is capped or limited.

FIG. 8C illustrates a block being added to a blockchain. Blocks can be added to the blockchain using proof of work or proof of stake as a means of verifying a proposed transaction. However, the process of adding blocks to the blockchain is not limited to the above two methods of verification. As shown in FIG. 8C, miners, which are computational devices operating as nodes on the blockchain network 150, receive the proposed transaction from the server gateway 120. Either all miners or a subset of miners, depending on the verification method, uses computational power to solve a complex mathematical problem. The first miner to successfully solve the complex mathematical problem, and to have majority agreement among other miners, receives a token as a reward. The proposed transaction block is confirmed and added to the blockchain.

FIG. 8D illustrates the secondary token reward process after a transaction is confirmed on the blockchain. The secondary token reward process can be divided into two parts: (1) an increase in crime tip value, or (2) a purchase by other users. In the first part, the user's crime tip is evaluated again against the collections of crime information from other users and external sources, such as but not limited to a social networks, social media, and news organizations. After the evaluation, the user's crime tip is assigned the same value as determined in FIG. 8B or is assigned an increase in value. If the value of the crime tip is increased, then the user receives a secondary token reward that is distributed to the user's hash address or unique ID address.

The second part of the token reward process occurs when other users or certain entities (e.g., government, enterprise, institutions, research) purchases crime intelligence reports using tokens. The purchase of crime intelligence reports is facilitated by smart contracts on the blockchain. After the purchase, a user receives the secondary token reward distribution to the user's hash address if the purchased crime intelligence report contains the user's crime tip.

FIG. 8E provides another overview of the same process as shown in FIG. 8A. Here, FIG. 8E provides more detail for the mining process and minimizes the detail for token initial /validation stage.

FIG. 8F illustrates the process for advertising from crime tips within a geographical area. As shown, a requesting user (e.g., government, enterprise, other users) specifies a geographical area for advertising for crime tips by providing a physical address (or location on map) and radius. The physical address (location on map) and radius is converted to GPS coordinates by using mapping software, such as Google Maps, or by similar means. The requesting user then submits payment in the form of tokens. Other users are notified of the request. If a user submits a crime tip within the geographical area, the user receives an increased token reward relative to the amount users would receive outside of the geographical area. To determine whether crime tip is located within the geographical area, the user's geographical area is also converted to GPS coordinates and compared to the GPS coordinators of geographical area for adverting for crime tips.

Returning to AI engine 134 to discuss in detail, the AI engine 134 preferably receives a plurality of different crime tips or other types of information from different users operating different user computational devices 102. In this case, preferably user app interface 112 and/or user computational device 102 is identified in such a way so as to be able to sort out duplicate tips or reported information, for example by identifying the device itself or by identifying the user through user app interface 112.

Recall that the AI engine 134 preferably removes any emotional content or bias from the crowdsourced information. For example, crime relates to people personally—whether to their body or their property. Therefore, crime tips impinge directly on preferred to prevent errors of judgement. For these types of information, removing any emotionally laden content is important to at least reduce bias.

During the evaluation process, the AI engine 134 also preferably determines a gradient of severity of the information, and specifically of the situation that is reported with the information. For example and without limitation, for crime, there is typically an unspoken threshold, gradient or severity in a community that determines when a crime would be reported. For a crime that is not considered to be sufficiently serious to call the police, individuals are more likely to report those crimes as crime tips. Thereby, providing more crime intelligence that would otherwise be available. Such crowdsourcing may be used to find small, early beginnings of crime and map trends and reports for the community.

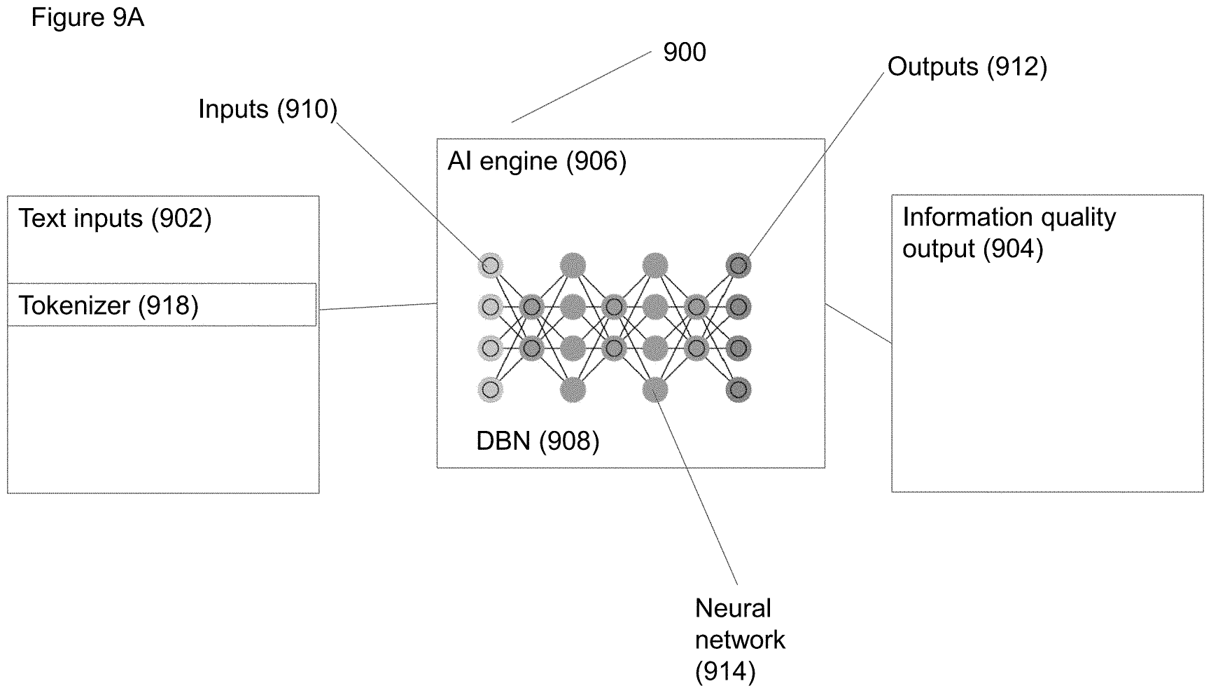

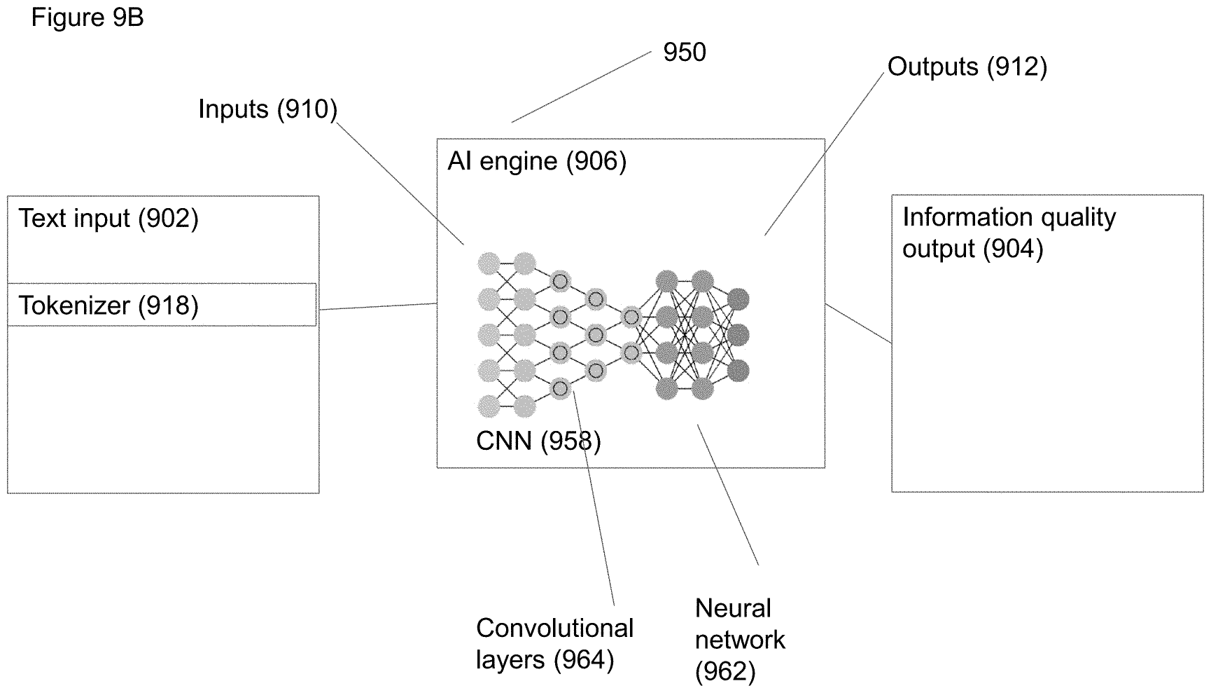

FIGS. 9A and 9B relate to non-limiting exemplary systems and flows for providing information to an artificial intelligence system with specific models employed and then analyzing it. Turning now to FIG. 9A as shown in a system 900, text inputs are preferably provided at 902 and preferably are also analyzed with the tokenizer in 918. A tokenizer is able to break down the text inputs into parts of speech. It is preferably also able to stem the words. For example, running and runs could both be stemmed to the word run. This tokenizer information is then fed into an AI engine in 906 and information quality output is provided by the AI engine in 904. In this non-limiting example, AI engine 906 comprises a DBN (deep belief network) 908. DBN 908 features input neurons 910 and neural network 914 and then outputs 912.

A DBN is a type of neural network composed of multiple layers of latent variables (“hidden units”), with connections between the layers but not between units within each layer.

FIG. 9B relates to a non-limiting exemplary system 950 with similar or the same components as FIG. 9A, except for the neural network model. In this case, a neural network 962 includes convolutional layers 964, neural network 962, and outputs 912. This particular model is embodied in a CNN (convolutional neural network) 958, which is a different model than that shown in FIG. 9A.

A CNN is a type of neural network that features additional separate convolutional layers for feature extraction, in addition to the neural network layers for classification/identification. Overall, the layers are organized in 3 dimensions: width, height and depth. Further, the neurons in one layer do not connect to all the neurons in the next layer but only to a small region of it. Lastly, the final output will be reduced to a single vector of probability scores, organized along the depth dimension. It is often used for audio and image data analysis, but has recently been also used for natural language processing (NLP; see for example Yin et al, Comparative Study of CNN and RNN for Natural Language Processing, arXiv:1702.01923v1 [cs.CL] 7 Feb. 2017).

Although not shown, a recurrent neural network (RNN) is a type of neural network where connection between nodes from a directed graph along a temporal sequence. This allows it to exhibit temporal dynamic behavior. Unlike feedforward neural networks, RNNs can use their state (memory) to process sequences of inputs. Thus, making RNNs applicable to task such as unsegmented, connected handwriting recognition, or speech recognition.

The term “recurrent neural network” is used indiscriminately to refer to two broad classes of networks with similar general structure, such as finite impulse and infinite impulse. Both classes of networks exhibit temporal dynamic behavior. A finite impulse recurrent network is a directed acyclic graph that can be unrolled and replaced with a strictly feedforward neural network, which an infinite impulse recurrent network is a directed cyclic graph that cannot be unrolled. Both finite impulse and infinite impulse recurrent networks can have additional stored state, and the storage can be under direct control by the neural network. This storage can be also be replaced by another network or graph, if the incorporates time delay or has feedback loops. Such controlled states are referred to as gated state or gated memory, and are part of long short-term memory networks (LSTMs) and gated recurrent units.

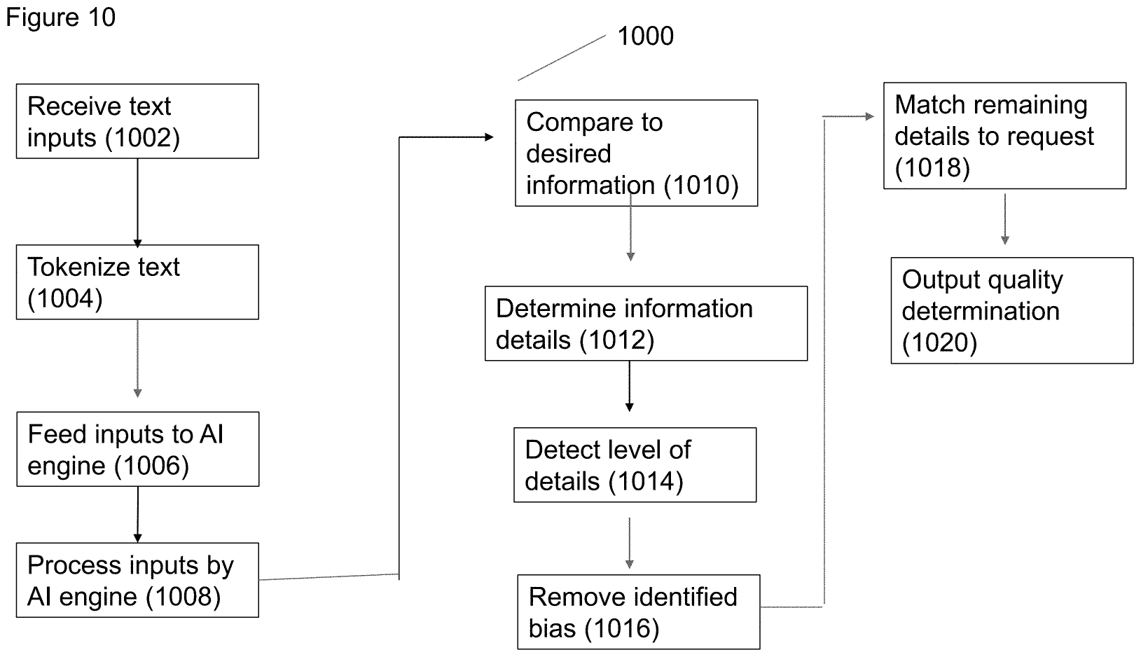

FIG. 10 relates to a non-limiting exemplary flow for analyzing information by an artificial intelligence engine as described herein. As shown with regards to a flow 1000, text inputs are received in 1002, and are then preferably tokenized in 1004, for example, according to the techniques described previously. Next, the inputs are fed to AI engine 1006, and the inputs are processed by the AI engine in 1008. The information received is compared to the desired information in 1010. The desired information preferably includes markers for details that should be included.

In the non-limiting example of crimes for example, the details that should be included preferably relate to such factors as the location of the alleged crime, preferably with regard to a specific address, but at least with enough identifying information to be able to identify where the crime took place, details of the crime such as who committed it, or who is viewed as committing it, if in fact the crime was viewed, and also the aftermath. Was there a broken window? Did it appear that objects had been stolen? Was a car previously present and then perhaps the hubcaps were removed? Preferably the desired information includes any information which makes it clear which crime was committed, when it was committed and where.

In 1012 then the information details are analyzed and the level of these details is determined in 1014. Any identified bias is preferably removed in 1016. For example with regard to crime tips, this may relate to sensationalized information such as, it was a massive fight, or information that is more emotional than relating to any specific details, such as for example the phrase “a frightening crime”. Other non-limiting examples include the race of the alleged perpetrator as this may this introduce bias into the system. Next, the remaining details are matched to the request in 1018 and the output quality is determined in 1020.

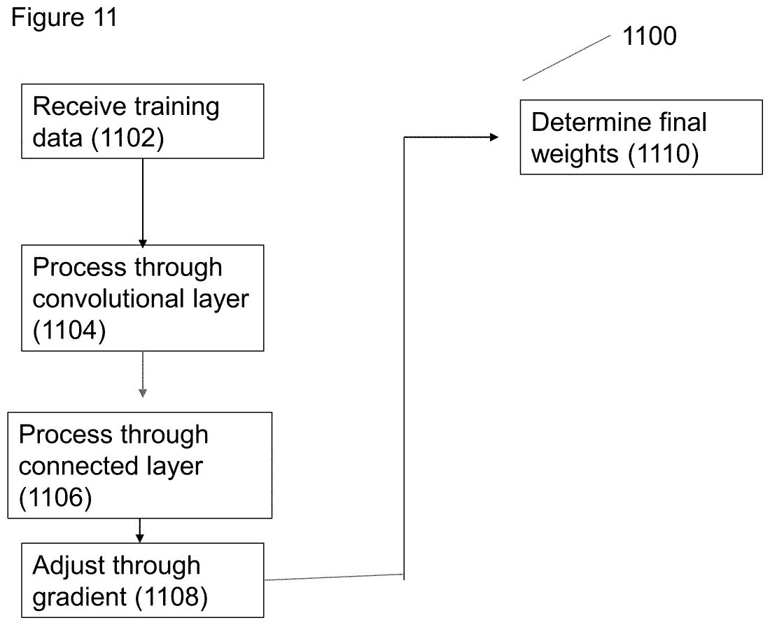

FIG. 11 relates to a non-limiting exemplary flow for training the AI engine. As shown with regard through flow 1100, the training data is received in 1102 and it's processed through the convolutional layer of the network in 1104. This is if a convolutional neural network is used, which is the assumption for this non-limiting example. After that the data is processed through the connected layer in 1106 and adjusted according to a gradient in 1108. Typically, a steep descent gradient is used in which the error is minimized by looking for a gradient. One advantage of this is it helps to avoid local minima where the AI engine may be trained to a certain point but may be in a minimum which is local but it's not the true minimum for that particular engine. The final weights are then determined in 1110 after which the model is ready to use.

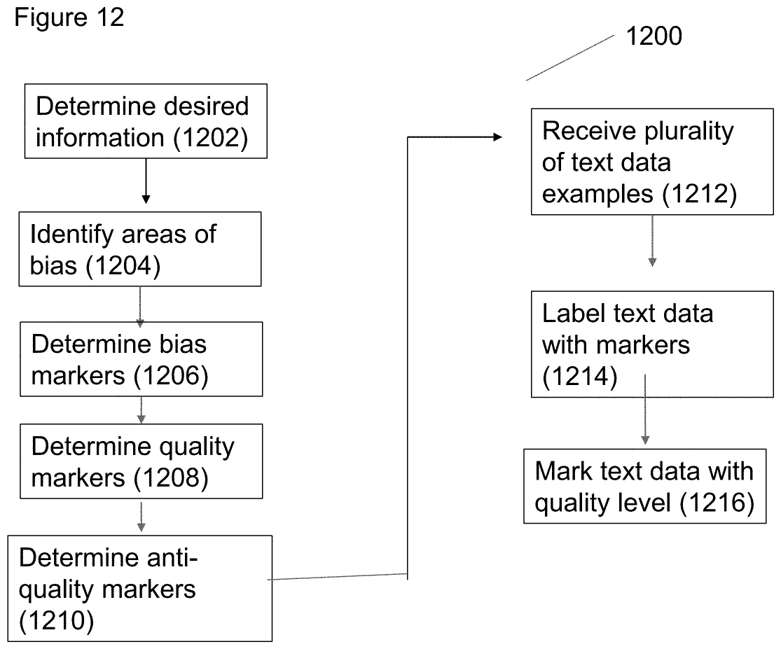

FIG. 12 relates to a non-limiting exemplary method for obtaining training data. As shown with regard to a flow 1200, the desired information is determined in 1202. For example, for crime tips, again, it's where the alleged crime took place, what the crime was, details of what happened, details about the perpetrator if in fact this person was viewed.

Next in 1204, areas of bias are identified. This is important in terms of adjectives, which may sensationalize the crimes such as a massive fight as previously described, but also of areas of bias which may relate to race. This is important for the training data because one does not want the AI model to be training on such factors as race but only on factors such as the specific details of the crime.

Next, bias markers are determined in 1206. These bias markers are markers which should be flagged and either removed or in some cases actually cause the entire information to be removed. These may include race, these include sensationalist adjectives, and other information which does not further relate to the concreteness of the details being considered.

Next, quality markers are determined in 1208. These may include a checklist of information. For example if the crime is burglary, one quality marker might be if any peripheral information is included such as for example whether a broken window is viewed at the property, if the crime took place in a particular property, what was stolen if that is no, other information such as whether or not a burglar alarm went off, the time at which the alleged crime took place, if the person is reporting it after the fact and didn't see the crime taking place, when did they report it, and when did they think the crime took place, and so forth.

Next, the anti-quality markers are determined in 1210. These are markers which detract from report. Sensationalist information for example can be stripped out, but it may also be used to detract from the quality of the report as would the race of the person if this is shown to include bias within the report. Other anti-quality markers could for example include details which could prejudice either an engine or a person viewing the information or the report towards a particular conclusion such as, “I believe so and so did this.” This could also be a quality marker, but it can also be an anti-quality marker, and how such information is handled depends also on how the people who are training the AI view the importance of this information.

Next, the plurality of text data examples are received in 1212, and then this text data is labeled with markers in 1214, assuming it does not come already labeled. Then the text data is marked with the quality level in 1216.

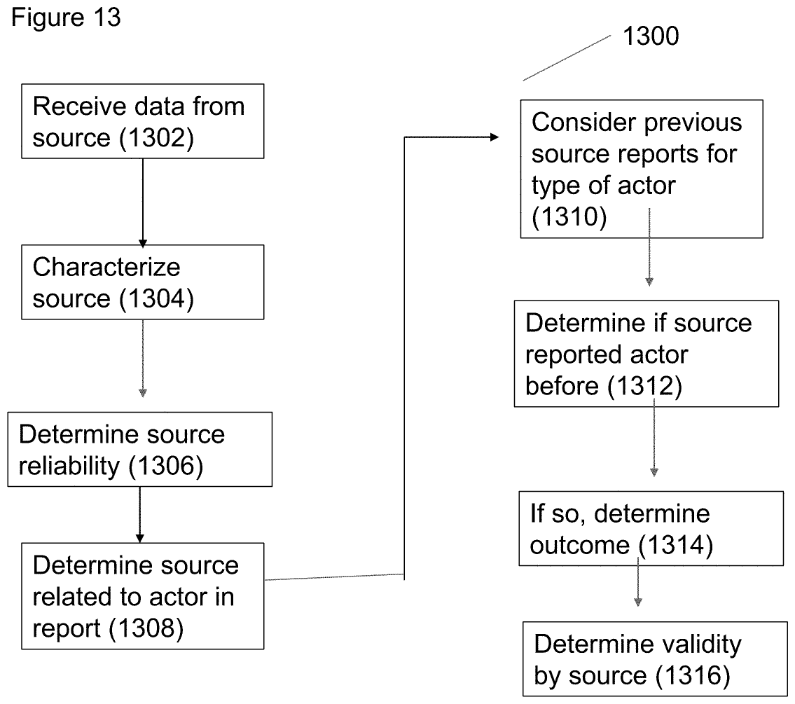

FIG. 13 relates to a non-limiting exemplary method for evaluating a source for data. As shown in the flow 1300, data is received from a source 1302, which for example could be a particular user identified as previously described. The source is then characterized in 1304. Characterization could include such information as the previous reliability of reports of the source, previous information given by the source, whether or not this is the first report, whether or not the report source has shown familiarity with the subject matter. For example, if a source is reporting a crime in a particular neighborhood, has the source reported that they previously or currently live in the neighborhood, regularly visit the neighborhood, were in the neighborhood for a meeting and noticed this, perhaps they go running, any information that would help characterize how and why the source might have come across this information, therefore why they should be trusted.

In other cases such as for example a matter which relates to subject matter expertise, for example for a particular type of request for biological information, what could be considered here would be the source's expertise. For example, if the source is a person, does the source have an educational background in this area, do they currently work in a lab, or have they previously worked in a laboratory in this area and so forth.

Next, the source's reliability is determined in 1306 from the characterization factors but also from previous reports given by the source. Next, it is determined whether the source is related to an actor in the report in 1308. In the case of a crime, this is particularly important. On the one hand, in some cases, if the source knows the actor, this could be advantageous. For example, if a source is reporting a burglary and they know the person who did it, and they saw the person with the stolen merchandise, this is clearly a factor in favor of the source's reliability. On the other hand, in other cases it might also be indication of a grudge, if the source is trying to implicate a particular person in a crime, this may be an indication that the source has a grudge against the person and therefore reduce their reliability. Whether the source is related to the actor is important, but may not be dispositive as for the reliability of the report.

Next, in 1310, the process considers previous source reports for this type of actor. This may be important in cases where a source repeatedly identifies actors by race, there may therefore be bias in this case, indicating that the person has a bias against a particular race. Another issue is also whether the source has reported this particular type of actor before in the sense of bias against juveniles, or bias against people who tend to hang out at a particular park or other location.

Next, in 1312, it is determined whether the source has reported the actor before. Again, as in 1308, this is a double-edge sword. If it indicates familiarity with the actor, it may be a good thing or it may indicate that the source has a grudge against the actor.

In 1314, the outcome is determined according to all of these factors such as the relationship between the source and the actor, whether or not the source has given previous reports for this type of actor or for this specific actor. Then the validity is determined by source in 1316, which may also include such factors as source characterization and source reliability.

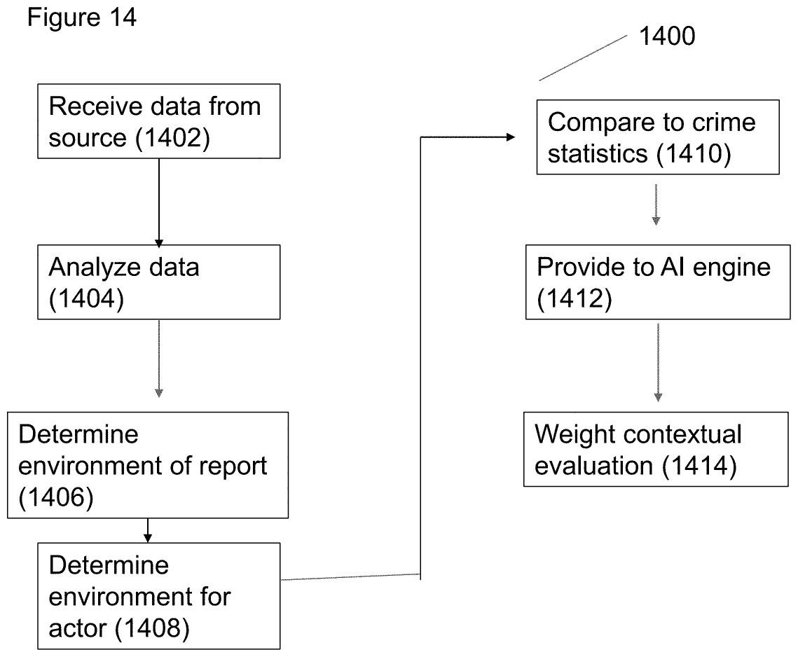

FIG. 14 relates to a non-limiting exemplary method for performing context evaluation for data. As shown in the flow 1400, data is received from a source, 1402, and is analyzed in 1404. Next, the environment of the report is determined in 1406. For example, for a crime, this could relate to the type of crime reported in a particular area. If a pickpocket event is reported in an area which is known to be frequented by pickpockets and have a lot of pick pocketing crime, this would tend to increase the validity of the report. On the other hand, if a report of a crime indicates that a TV was stolen from a store but there were no stores selling TVs in that particular area, then that would reduce the validity of the report given that the environment does not have any stores that would sell the object that was apparently stolen.

In 1408, the environment for the actor is determined. Again, this relates to whether or not the actor is likely to have been in a particular area at a particular time. If a particular actor is named and that actor lives on a different continent and was not actually visiting the continent or country in question at the time, this would clearly reduce the validity of the report. Also, if one is discussing a crime by a juvenile, and this is during school hours, it would also then actually determine whether or not the juvenile actually had attended school. If the juvenile had been in school all day, then this would again count against the environmental analysis.

In 1410 the information is compared to crime statistics, again, to determine likelihood of crime, and all this information is provided to the AI engine in 1412. In 1414 the contextual evaluation is then weighted. These are all the different contexts for the data and the AI engine determines whether or not based on these contexts the event was more or less likely to have occurred as reported and also the relevance and reliability of the report.

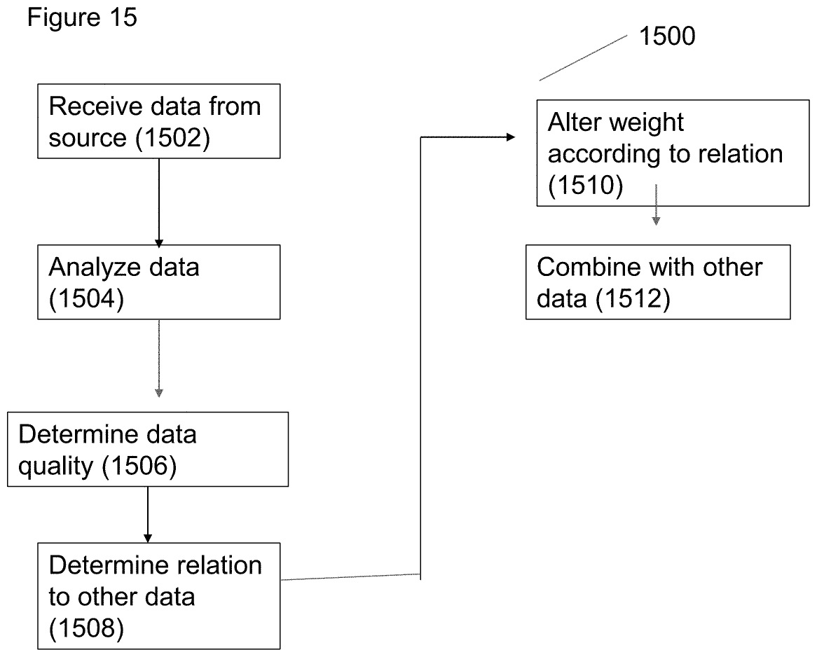

FIG. 15 relates to a non-limiting exemplary method for connection evaluation for data. The connections that are evaluated preferably relate to connections or relationships between various sets or types of data, or data components. As shown in the flow 1500, data is received from the source 1502 and analyzed in 1504. Optionally such analysis includes decomposing the data into a plurality of components, and/or characterizing the data according to one or more quality markers. A non-limiting example of a component is for example a graph, a number or set of numbers, or a specific fact. With regard to the example of a crime tip or report, the specific fact may relate to a location of a crime, a time of occurrence of the crime, the nature of the crime and so forth.

The data quality is then determined in 1506. , for example according to one or more quality markers determined in 1504. Optionally data quality is determined per component. Next, the relationship between this data and other data is determined in 1508. For example, the relationship could be multiple reports for the same crime. If there are multiple reports for the same crime, the importance would be then connecting these reports and showing whether or not the data in the news report substantiates the data in previous report, contradicts the data in previous reports, and also whether or not multiple reports solidify each other's data or contradict each other's data.

This is important because if there are multiple conflicting reports, if it is not clear what crime exactly occurred, or details of the crime such when and how or what happened, or if something was stolen, what was stolen, then this would indicate that the multiple reports are less reliable because reports should preferably reinforce each other.

The relationship may also be determined for each component of the data separately, or for a plurality of such components in combination.

In 1510, the weight is altered according to the relationship between the received data and previously known data, and then all of the data is preferably combined in 1512.

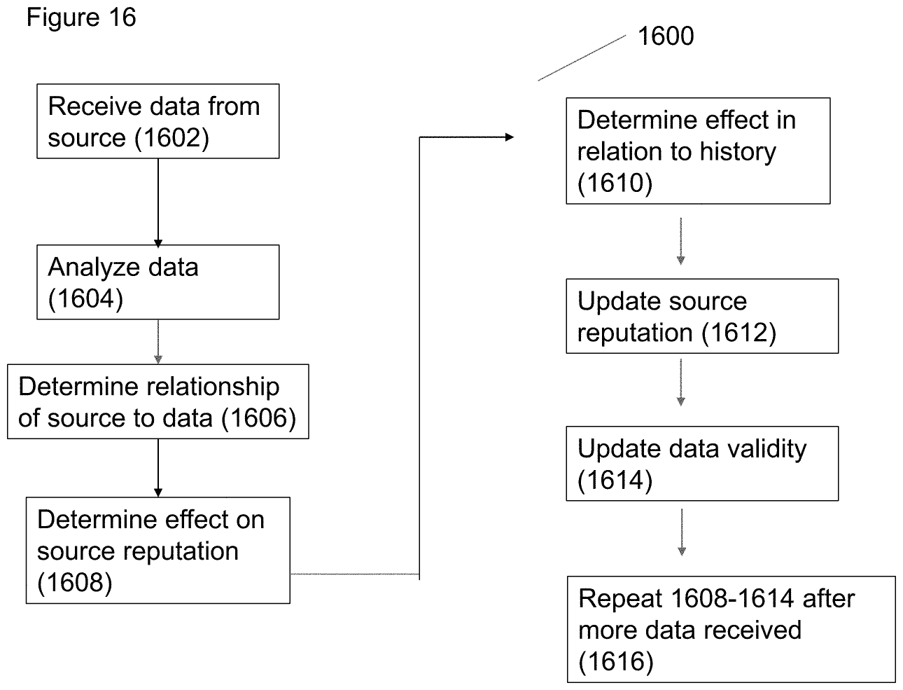

FIG. 16 relates to a non-limiting exemplary method for source reliability evaluation. In this context, the term “source” may for example relate to a user as described herein (such as the user of FIG. 1) or to a plurality of users, including without limitation an organization. A method 1600 begins by receiving data from a source 1602. The data is identified as being received from the source, which is preferably identifiable at least with a pseudonym, such that it is possible to track data received from the source according to a history of receipt of such data.

Next the data is analyzed in 1604. Such analysis may include but is not limited to decomposing the data into a plurality of components, determining data quality, analyzing the content of the data, analyzing metadata and a combination thereof. Other types of analysis as described herein may be performed, additionally or alternatively.

In 1606, a relationship between the source and the data is determined. For example, the source may be providing the data as an eyewitness account. Such a direct account is preferably given greater weight than a hearsay account. Another type of relationship may involve the potential for a motive involving personal gain, or gain of a related third party, through providing the data. In case of a reward or payment being offered for providing the data, the act of providing the data itself would not necessarily be considered to indicate a desire for personal gain. For scientific data, the relationship may for example be that of a scientist performing an experiment and reporting the results as data. The relationship may increase the weight of the data, for example in terms of determining data quality, or may decrease the weight of the data, for example if the relationship is determined to include a motive related to personal gain or gain of a third party.

In 1608, the effect of the data on the reputation of the source is determined, preferably from a combination of the data analysis and the determined relationship. For example, high quality data and/or data provided by a source that has been determined to have a relationship that involves personal gain and/or gain for a third party may increase the reputation of the source. Low quality data and/or data provided by a source that has been determined to have a relationship involving such gain may decrease the reputation of the source. Optionally the reputation of the source is determined according to a reputation score, which may comprise a single number or a plurality of numbers. Optionally, the reputation score and/or other characteristics are used to place the source into one of a plurality of buckets, indicating the trustworthiness of the source—and hence also of data provided by that source.

The effect of the data on the reputation of the source is also preferably determined with regard to a history of data provided by the source in 1610. Optionally the two effects are combined, such that the reputation of the source is updated for each receipt of data from the source. Also optionally, time is considered as a factor. For example, as the history of receipts of data from the source evolves over a longer period of time, the reputation of the source may be increased also according to the length of time for such history. For example, for two sources which have both made the same number of data provisions, a greater weight may be given to the source for which such data provisions were made over a longer period of time.

In 1612, the reputation of the source is updated, preferably according to the calculations in both 1608 and 1610, which may be combined according to a weighting scheme and also according to the above described length of elapsed time for the history of data provisions.

In 1614, the validity of the data is optionally updated according to the updated source reputation determination. For example, data from a source with a higher determined reputation is optionally given a higher weight as having greater validity.

Optionally, 1608-1614 are repeated at least once, after more data is received, in 1016. The process may be repeated continuously as more data is received. Optionally the process is performed periodically, according to time, rather than according to receipt of data. Optionally a combination of elapsed time between performing the process and data receipt is used to trigger the process.

Optionally reputation is a factor in determining the speed of remuneration of the source, for example. A source with a higher reputation rating may receive remuneration more quickly. Different reputation levels may be used, with a source progressing through each level as the source provides consistently valid and/or high quality data over time. Time may be a component for determining a reputation level, in that the source may be required to provide multiple data inputs over a period of time to receive a higher reputation level. Different reputation levels may provide different rewards, such as higher and/or faster remuneration for example.

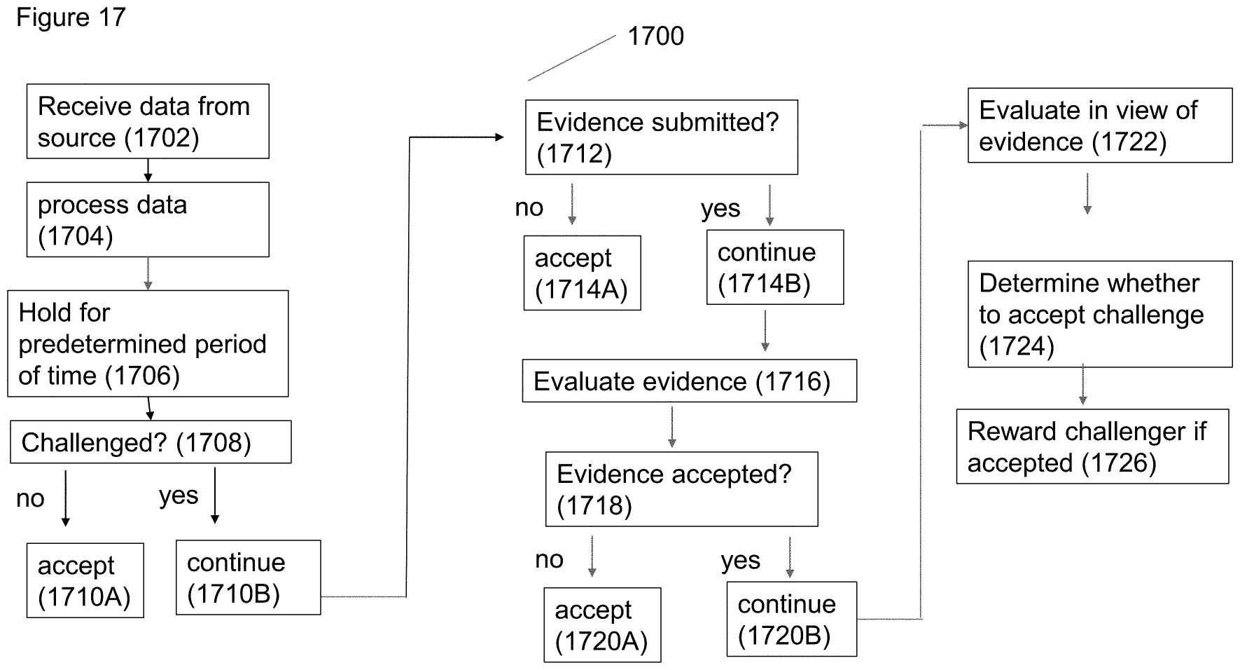

FIG. 17 relates to a non-limiting exemplary method for a data challenge process. The data challenge process may be used to challenge the validity of data that is provided, in whole or in part. A process 1700 begins with receiving data from a source in 1702, for example as previously described. In 1704, the data is processed, for example to analyze it and/or associated metadata, for example as described herein. A hold is then placed on further processing, analysis and/or use of the data in 1706, to allow time for the data to be challenged. For example, the data may be made available to one or more trusted users and/or sources, and/or to external third parties, for review. A reviewer may then challenge the validity of the data during this holding period.

If the validity of the data is not challenged in 1708, then the data is accepted in 1110A, for example for further analysis, processing and/or use. The speed with which the data is accepted, even if not challenged, may vary according to a reputation level of the source. For example, for sources with a lower reputation level, a longer period of time may elapse before the data is accepted. For sources with a lower reputation level, there may be a longer period of time during which challenges may be made. By contrary, for sources with a higher reputation level, such a period of time for challenges may be shorter. As a non-limiting example, for sources with a lower reputation level, the period of time for challenges may be up to 12 hours, up to 24 hours, up to 48 hours, up to 168 hours, up to two weeks or any time period in between. For sources with a higher reputation level, such a period of time may be shortened, by 25%, 50%, 75% or any other percentage amount in between

If the validity of the data is challenged in 1708, then a challenge process is initiated in 1710B. The challenger is invited to provide evidence to support the challenge in 1712. If the challenger does not submit evidence, then the data is accepted as previously described in 1714A. If evidence is submitted, then the challenge process continues in 1714B.

The evidence is preferably evaluated in 1716, for example for quality of the evidence, the reputation of the evidence provider, the relationship between the evidence provider and the evidence, and so forth. Optionally and preferably the same or similar tools and processes are used to evaluate the evidence as described herein for evaluating the data and/or the reputation of the data provider. The evaluation information is then preferably passed to an acceptance process in 1118, to determine whether the evidence is acceptable. If the evidence is not acceptable, then the data is accepted as previously described in 1720A.

If the evidence is acceptable, then the challenge process continues in 1720B. The challenged data is evaluated in light of the evidence in 1722. If only one or a plurality of data components were challenged, then preferably only these components are evaluated in light of the provided evidence. Optionally and preferably, the reputation of the data provider and/or of the evidence provider are included in the evaluation process.

In 1724, it is determined whether to accept the challenge, in whole or in part. If the challenge is accepted, in whole or optionally in part, the challenger is preferably rewarded in 1726. The data may be accepted, in whole or in part, according to the outcome of the challenge. If accepted, then its weighting or other validity score may be adjusted according to the outcome of the challenge. Optionally and preferably, the reputation of the challenger and/or of the data provider is adjusted according to the outcome of the challenge.

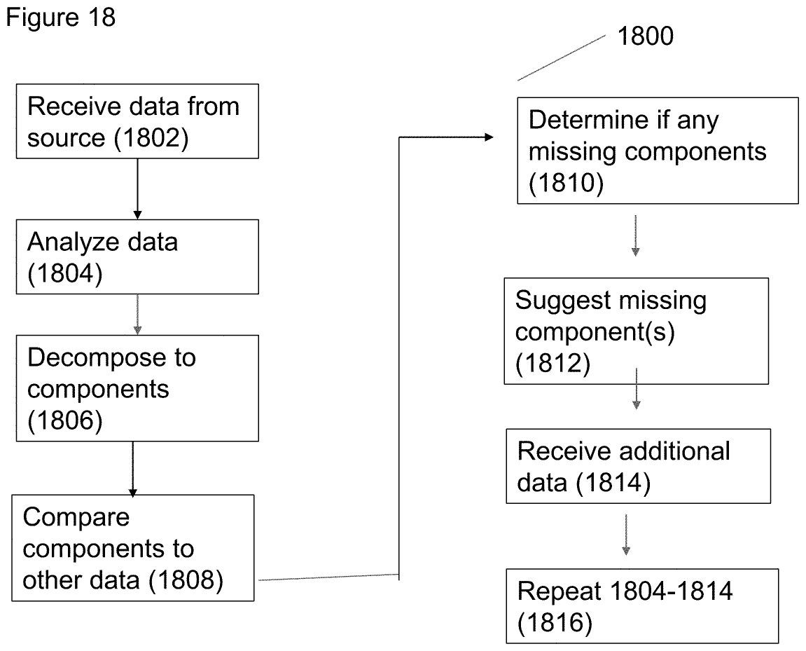

FIG. 18 relates to a non-limiting exemplary method for a reporting assistance process. This process may be performed for example through the previously described user app, such that when a user (or optionally a source of any type) reports data, assistance is provided to help the user provide more complete or accurate data. A process 1800 begins with receiving data from a source, such as a user, in 1802. The data may be provided through the previously described user app or through another interface. The subsequent steps described herein may be performed synchronously or asynchronously. The data is then analyzed in 1804, again optionally as previously described. In 1806, the data is preferably broken down into a plurality of components, for example through natural language processing as previously described.

The data components are then preferably compared to other data in 1808. For example, the components may be compared to parameters for data that has been requested. For the non-limiting example of a crime tip or report, such parameters may relate to a location of the crime, time and date that the crime occurred, nature of the crime, which individual(s) were involved and so forth. Preferably such a comparison is performed through natural language processing.

As a result of the comparison, it is determined whether any data components are missing in 1810. Again for the non-limiting example of a crime tip or report, if the data components do not include the location of the crime, then the location of the crime is determined to be a missing data component. For each missing component, optionally and preferably a suggestion is made as to the nature of the missing component in 1812. Such a suggestion may include a prompt to the user making the report, for example through the previously described user app. As a result of the prompts, additional data is received in 1814. The process of 1804-1814 may then be repeated more than once in 1816, for example until the user indicates that all missing data has been provided and/or that the user does not have all answers for the missing data.

FIG. 19 illustrates a method of securing the user wallet 116 through a verifiable means of connecting wallet seeds in an obfuscated way with a particular known user identity. A user creates a user wallet 116 on the user computational device 102 and provides a password to the user wallet 116 (Step 1902). The user wallet 116 generates a seed and salt and obfuscates the seed using encryption (Step 1904). The user wallet 116 then pings a server 120 with the obfuscated seed and salt for the user account, where the user account is located on the user computational device 102 (Step 1906). The obfuscated seed is also encrypted on the server 120. The server 120 places the salt, the obfuscated seed, and a generated account id (pseudo-random hash) into the user store, where the generated account id is used to track data coming from the user computational device 102 (Step 1908).

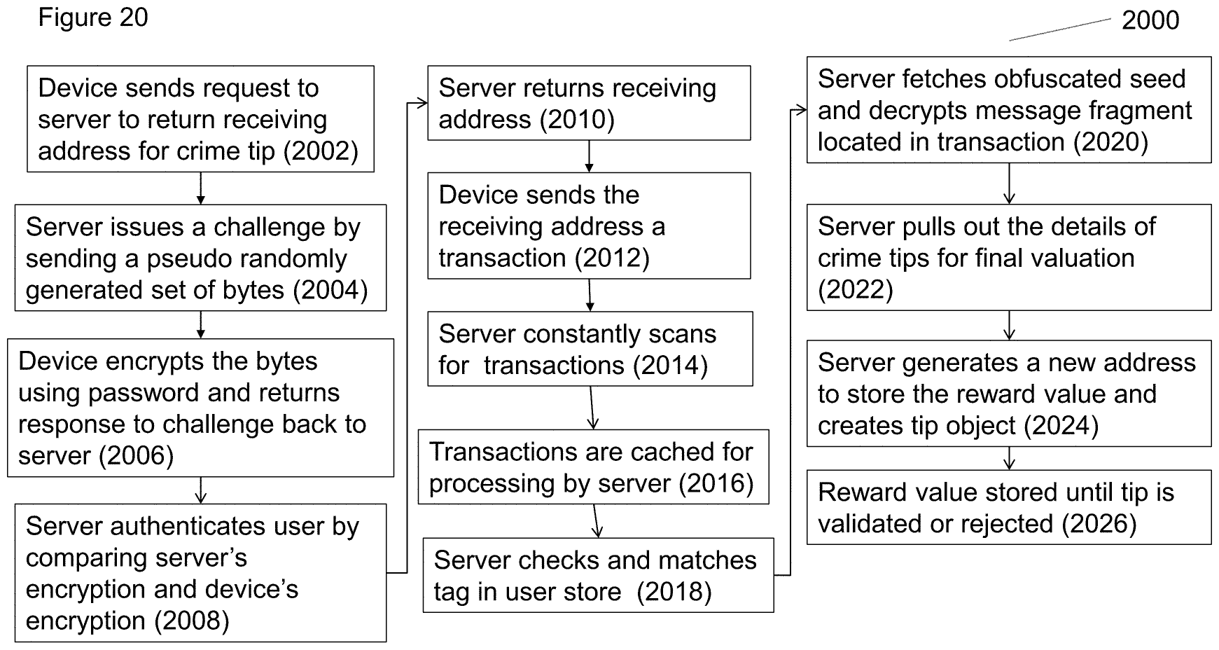

FIG. 20 illustrates a method of user creating a crime tip. When a user wishes to create a crime tip (or crime tip information), the user sends a request via the user computational device 102 to the server 120 to return a receiving address for the crime tip information (Step 2002). The server 120 then issues a challenge to the user computational device 120 by sending a pseudo randomly generated set of bytes (Step 2004). The user computational device 102 encrypts the bytes using the password and returns a response to the challenge back to the server 120 (Step 2006).

The server 120 authenticates the user by verifying that the server's encryption is of the same nonce is the same as the one that server 120 received from the user computational device 102 (Step 2008). The server 120 returns the receiving address (Step 2010). The server 120 generates these receiving addresses on a rotation every hour to reduce loads for fetching and reduce the possibility of “DOSing” the nodes.

The user computational device 102 sends a transaction to the receiving address provided by the server 120 (Step 2012). The transaction contains all of the user provided crime tip information in the message fragment and encrypted data, which is encrypted using the obfuscated seed. The transaction also includes a list of potential addresses to send the value to in the event that a crime tip is created and then verified. The tag field contains the Tryte representation of the user's identifier.

The server constantly scans the tangle for transactions associated with the presently engaged acceptance address (Step 2014). Transactions found in this way are cached for processing by the server 120 (Step 2016). While processing, the server 120 first checks that the tag that is presented in the user store (Step 2018). After determining a match, the server 120 then fetches the obfuscated seed from the store and decrypts the message fragment (Step 2020). The server 120 then pulls out the details of the crime tip, including the potential send addresses, for final valuation (Step 2022).

The server 120 generates a new address to store the reward value and creates a tip object in the database associated with the original transaction hash (Step 2024). This transaction acts as the entry point for all tip verifications and stores the value of the tip until it has been validated or rejected (Step 2026).

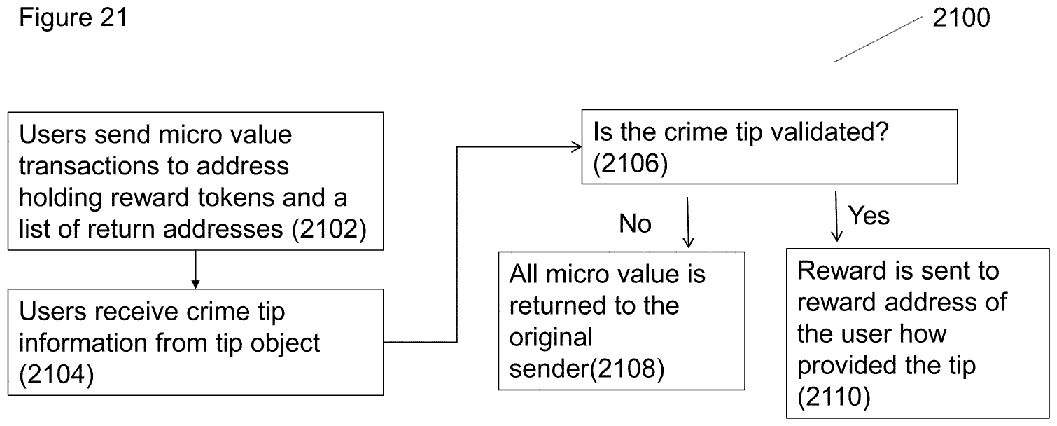

FIG. 21 illustrates the method of users validating or rejecting a crime tip. The method starts with users sending micro value transactions to the address holding the reward tokens (Step 2102). Users also send a list of return addresses in the event of a tip rejection. The users receives crime tip information from the tip object, where receiving the information is automated through a software development kit (SDK) (Step 2104).

The crime tip goes through the validation process (Step 2006). If a tip is rejected, all of the micro value in the reward pool is returned to the original senders in one large bundle transaction (Step 2008). If the tip is validated, then the reward is sent to the reward address of the user who provided the tip (Step 2010).

To analyze the transactions, all transaction hashes, which have been stored in cache as having been proper tips, are pulled and then scanned through these transactions by tag to compare with user id's. Thus, this allows reputations and patterns to be associated with users, without ever providing any direct information on the user.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for creating and providing crime intelligence based on crowdsourced information, the system comprises
a. a plurality of user computational devices, each user computational device comprising a user app interface;
b. a server, comprising a server app interface, an artificial intelligence (AI) engine, and a blockchain node;
c. a computer network for connecting said computational device and said server; and
d. blockchain network, comprising of a plurality of blockchain nodes and a plurality of blockchains;
e. wherein crowdsourced information is provided through each user app interface and is analyzed by said AI engine;
f. wherein said AI engine determines a quality of said information received through each user app; and
g. wherein said blockchain node of the said server writes to and reads from a blockchain located on said blockchain network.

2. The system of claim 1, wherein said user computational device further comprises a user input device, and a user display device, a user processor, and user memory, wherein said user memory stores a defined native instruction set of codes; wherein said user processor is configured to perform a defined set of basic operations in response to receiving a corresponding basic instruction selected from said defined native instruction set of codes; wherein said user computational device comprises a first set of machine codes selected from the native instruction set for receiving information through said user app and a second set of machine codes selected from the native instruction set for transmitting said information to said server as said crowdsourced information.

3. The system of claim 1, wherein the said server further comprises a server processor and a server memory, wherein said server memory stores a defined native instruction set of codes; wherein said server processor is configured to perform a defined set of basic operations in response to receiving a corresponding basic instruction selected from said defined native instruction set of codes; wherein said server comprises a first set of machine codes selected from the native instruction set for receiving crowdsourced information from said user computational devices, and a second set of machine codes selected from the native instruction set for executing functions of said AI engine.

4. The system of claim 1, wherein said computer network is the internet, which is the global system of interconnected computer networks that use the Internet protocol suite (TCP/IP) to link devices worldwide.

5. The system of claim 1, wherein the said blockchain further comprises smart contracts.

6. The system of claim 1, wherein said AI engine comprises deep learning and/or machine learning algorithms.

7. The system of claim 6, wherein said AI engine further comprises an algorithm selected from the group consisting of word2vec, a deep belief network (DBN), a convolutional neural network (CNN), and a recurrent neural network (RNN).

8. A system for creating and providing crime intelligence based on crowdsourced information, the system comprises
a. a plurality of user computational devices, each user computational device comprising a user app interface;
b. a server, comprising a server app interface, an artificial intelligence (AI) engine, and a blockchain node;
c. a computer network for connecting said computational device and said server; and
d. blockchain network, comprising of a plurality of blockchain nodes and a plurality of blockchains;
e. a user wallet that communicates with said user computational device;
f. wherein crowdsourced information is provided through each user app interface and is analyzed by said AI engine;
g. wherein said AI engine determines a quality of said information received through each user app; and
h. wherein said blockchain node of the said server writes to and reads from a blockchain located on said blockchain network.

9. The system of claim 8, wherein said user computational device further comprises a user input device, and a user display device, a user processor, and user memory, wherein said user memory stores a defined native instruction set of codes; wherein said user processor is configured to perform a defined set of basic operations in response to receiving a corresponding basic instruction selected from said defined native instruction set of codes; wherein said user computational device comprises a first set of machine codes selected from the native instruction set for receiving information through said user app and a second set of machine codes selected from the native instruction set for transmitting said information to said server as said crowdsourced information.

10. The system of claim 8, wherein said server further comprises a server processor and a server memory, wherein said server memory stores a defined native instruction set of codes; wherein said server processor is configured to perform a defined set of basic operations in response to receiving a corresponding basic instruction selected from said defined native instruction set of codes; wherein said server comprises a first set of machine codes selected from the native instruction set for receiving crowdsourced information from said user computational devices, and a second set of machine codes selected from the native instruction set for executing functions of said AI engine.

11. The system of claim 8, wherein said computer network is the internet, which is the global system of interconnected computer networks that use the Internet protocol suite (TCP/IP) to link devices worldwide.

12. The system of claim 8, wherein said user wallet communicates with said server.

13. The system of claim 12, wherein the communication between said user wallet and said server involves said user wallet transmitting an obfuscated seed and salt to said server; said server authenticating user using the obfuscated seed, salt, and challenge, and returning receiving address for transaction submission by said user wallet; and said user wallet sending transactions for validation.

14. The system of claim 13, where transactions comprises crime tip information in the message fragment, encrypted data, and a list of potential addresses to send value to in the event that a crime tip is created and then verified.

15. The system of claim 8, wherein a wallet manager manages said user wallet.

16. The system of claim 8, wherein the said blockchain further comprises smart contracts.

17. The system of claim 15, wherein said wallet manage further comprises a blockchain node that communicates with said blockchain network;

18. A method for creating and providing crime intelligence based on crowdsourced information, the method comprises operating a system to any of the above claims, further comprising receiving crowdsource information; analyzing crowdsourced information by said AI engine; providing tokens as a reward for timely, valuable, and accurate crime tips; writing to and reading from the blockchain, creating and providing crime intelligence reports based on submitted crime tips; and receiving payment for requesting crime intelligence reports and for requesting submission of crime tips for a geographical area.
